(19) United States
(12) Patent Application Publication
(10) Pub. No.: US 2026/0172201 A1
(43) Pub. Date: Jun. 18, 2026

(54) TWO PART HYBRID AUTOMATIC REPEAT REQUEST ACKNOWLEDGEMENT (HARQ-ACK) FEEDBACK USING A MEDIUM ACCESS CONTROL (MAC) CONTROL ELEMENT (MAC-CE)

(71) Applicant: QUALCOMM Incorporated, San Diego, CA (US)

(72) Inventors: Morteza SOLTANI, San Diego, CA (US); Mostafa KHOSHNEVISAN, San Diego, CA (US); Jing SUN, San Diego, CA (US); Gabi SARKIS, San Diego, CA (US)

(21) Appl. No.: 18/986,487

(22) Filed: Dec. 18, 2024

(51) Int. Cl. H04L 5/00

(52) U.S. Cl. CPC H04L 5/0055; H04L 5/0044

(57) ABSTRACT

Certain aspects of the present disclosure provide techniques for communicating hybrid automatic repeat request acknowledgement (HARQ-ACK) feedback. A method generally includes receiving a plurality of downlink transmissions; transmitting one or more signals comprising: a medium access control (MAC) control element (MAC-CE); and a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions; and the MAC-CE comprises one or more of: the first HARQ-ACK part, the second HARQ-ACK part, or the HARQ-ACK payload; and transmitting, via a physical uplink shared channel (PUSCH), the MAC-CE jointly encoded with an uplink payload.

### INTRODUCTION

### Field of the Disclosure

Aspects of the present disclosure relate to wireless communications, and more particularly, to techniques for communicating hybrid automatic repeat request acknowledgement (HARQ-ACK) feedback.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving a plurality of downlink transmissions; transmitting one or more signals comprising: a medium access control (MAC) control element (MAC-CE); a first hybrid automatic repeat request acknowledgement (HARQ-ACK) part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload; and transmitting, via a physical uplink shared channel (PUSCH), the MAC-CE jointly encoded with an uplink payload.

Another aspect provides one or more apparatuses configured for wireless communications. The one or more apparatuses include one or more processing systems that include one or more processors and one or more memories coupled with the one or more processors. The one or more processing systems are configured to cause the one or more apparatuses to receive a plurality of downlink transmissions; transmit one or more signals comprising: a MAC-CE; a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload; and transmit, via a PUSCH, the MAC-CE jointly encoded with an uplink payload.

Another aspect provides one or more apparatuses configured for wireless communications. The one or more apparatuses include means for receiving a plurality of downlink transmissions; means for transmitting one or more signals comprising: a MAC-CE; a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first

HARQ-ACK part, the second HARQ-ACK part, or the HARQ-ACK payload; and means for transmitting, via a PUSCH, the MAC-CE jointly encoded with an uplink payload.

Another aspect provides one or more non-transitory computer-readable media. The one or more non-transitory computer-readable media include executable instructions that, when executed by one or more processors of one or more apparatuses, cause the one or more apparatuses to receive a plurality of downlink transmissions; transmit one or more signals comprising: a MAC-CE; a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload; and transmit, via a PUSCH, the MAC-CE jointly encoded with an uplink payload.

In some examples of the methods, apparatuses, and non-transitory computer-readable media described herein, the MAC-CE comprises the second HARQ-ACK part without the first HARQ-ACK part.

Some examples of the methods, apparatuses, and non-transitory computer-readable media described herein may further include operations, features, means, or instructions for separately encoding the first HARQ-ACK part; and block 1410 includes transmitting, via a PUCCH, the first HARQ-ACK part.

In some examples of the methods, apparatuses, and non-transitory computer-readable media described herein, the PUCCH and the PUSCH overlap in a time domain.

In some examples of the methods, apparatuses, and non-transitory computer-readable media described herein, a time period associated with the PUSCH is later in time than a time period associated with the PUCCH.

In some examples of the methods, apparatuses, and non-transitory computer-readable media described herein, transmitting the first HARQ-ACK part comprises transmitting each of a plurality of first HARQ-ACK parts, including the first HARQ-ACK part, via a respective PUCCH; the second HARQ-ACK part is one of a plurality of second HARQ-ACK parts pending transmission; and each second HARQ-ACK part is associated with a respective first HARQ-ACK part of the plurality of first HARQ-ACK parts.

In some examples of the methods, apparatuses, and non-transitory computer-readable media described herein, the MAC-CE comprises each second HARQ-ACK part of the plurality of second HARQ-ACK parts.

In some examples of the methods, apparatuses, and non-transitory computer-readable media described herein, the MAC-CE further comprises, for each second HARQ-ACK part of the plurality of second HARQ-ACK parts, a respective indication of a respective time period when the associated first HARQ-ACK part was transmitted.

In some examples of the methods, apparatuses, and non-transitory computer-readable media described herein, the MAC-CE further comprises an indication of an order associated with the plurality of second HARQ-ACK parts.

In some examples of the methods, apparatuses, and non-transitory computer-readable media described herein, the second HARQ-ACK part is associated with the first HARQ-ACK part; and the first HARQ-ACK part is transmitted latest in time among the plurality of first HARQ-ACK parts.

In some examples of the methods, apparatuses, and non-transitory computer-readable media described herein, the MAC-CE comprises a subset of the plurality of second HARQ-ACK parts; and the subset comprises at least the second HARQ-ACK part.

Some examples of the methods, apparatuses, and non-transitory computer-readable media described herein may further include operations, features, means, or instructions for receiving signaling configuring a number of second HARQ-ACK parts to be included in the subset of the plurality of second HARQ-ACK parts.

In some examples of the methods, apparatuses, and non-transitory computer-readable media described herein, the MAC-CE further comprises an indication of an order associated with the subset of the plurality of second HARQ-ACK parts.

In some examples of the methods, apparatuses, and non-transitory computer-readable media described herein, the MAC-CE comprises the first HARQ-ACK part and the second HARQ-ACK part.

In some examples of the methods, apparatuses, and non-transitory computer-readable media described herein, a first field of the MAC-CE comprises the first HARQ-ACK part; and one or more other fields of the MAC-CE comprise at least the second HARQ-ACK part.

Some examples of the methods, apparatuses, and non-transitory computer-readable media described herein may further include operations, features, means, or instructions for receiving signaling configuring the UE to include the first HARQ-ACK part in the first field of the MAC-CE and the second HARQ-ACK part in the one or more other fields of the MAC-CE.

In some examples of the methods, apparatuses, and non-transitory computer-readable media described herein, the first field indicates a size of at least one of the one or more other fields of the MAC-CE.

In some examples of the methods, apparatuses, and non-transitory computer-readable media described herein, the MAC-CE comprises the first HARQ-ACK part without the second HARQ-ACK part.

In some examples of the methods, apparatuses, and non-transitory computer-readable media described herein, the respective HARQ feedback for each downlink transmission of the plurality of downlink transmissions comprises respective ACK feedback for each downlink transmission of the plurality of downlink transmissions.

Some examples of the methods, apparatuses, and non-transitory computer-readable media described herein may further include operations, features, means, or instructions for receiving a request to include the first HARQ-ACK part and the second HARQ-ACK part in the MAC-CE.

In some examples of the methods, apparatuses, and non-transitory computer-readable media described herein, receiving the request comprises receiving DCI scheduling the PUSCH, the DCI comprising the request.

Some examples of the methods, apparatuses, and non-transitory computer-readable media described herein may further include operations, features, means, or instructions for receiving a request to include the second HARQ-ACK part in the MAC-CE without including the first HARQ-ACK part in the MAC-CE.

Some examples of the methods, apparatuses, and non-transitory computer-readable media described herein may further include operations, features, means, or instructions for separately encoding the first HARQ-ACK part.

Some examples of the methods, apparatuses, and non-transitory computer-readable media described herein may further include operations, features, means, or instructions for receiving DCI scheduling the PUSCH and comprising an indication that a network entity successfully decoded the first HARQ-ACK part; and block 1410 includes transmitting, via a PUCCH, the first HARQ-ACK part.

In some examples of the methods, apparatuses, and non-transitory computer-readable media described herein, receiving the request comprises receiving DCI scheduling the PUSCH, the DCI comprising the request.

Some examples of the methods, apparatuses, and non-transitory computer-readable media described herein may further include operations, features, means, or instructions for separately encoding the first HARQ-ACK part.

Some examples of the methods, apparatuses, and non-transitory computer-readable media described herein may further include operations, features, means, or instructions for receiving DCI scheduling the PUSCH and comprising an indication that a network entity failed to decode the first HARQ-ACK part; and block 1410 includes transmitting, via a PUCCH, the first HARQ-ACK part.

In some examples of the methods, apparatuses, and non-transitory computer-readable media described herein, the MAC-CE comprises the HARQ-ACK payload without the first HARQ-ACK part and without the second HARQ-ACK part.

In some examples of the methods, apparatuses, and non-transitory computer-readable media described herein, the MAC-CE comprises the first HARQ-ACK part and the second HARQ-ACK part.

In some examples of the methods, apparatuses, and non-transitory computer-readable media described herein, the MAC-CE comprises the second HARQ-ACK part without the first HARQ-ACK part.

Some examples of the methods, apparatuses, and non-transitory computer-readable media described herein may further include operations, features, means, or instructions for jointly encoding UCI with the first HARQ-ACK part.

Some examples of the methods, apparatuses, and non-transitory computer-readable media described herein may further include operations, features, means, or instructions for multiplexing the UCI on the PUSCH.

In some examples of the methods, apparatuses, and non-transitory computer-readable media described herein, a size of the second HARQ-ACK part is a function of the first HARQ-ACK part.

In some examples of the methods, apparatuses, and non-transitory computer-readable media described herein, a size of the first HARQ-ACK part is fixed.

One aspect provides a method for wireless communications by a network entity. The method includes transmitting a plurality of downlink transmissions; receiving one or more signals comprising: a MAC-CE; a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload; and receiving, via a PUSCH, the MAC-CE jointly encoded with an uplink payload.

Another aspect provides one or more apparatuses configured for wireless communications. The one or more apparatuses include one or more processing systems that include one or more processors and one or more memories coupled with the one or more processors. The one or more processing systems are configured to cause a network entity to transmit a plurality of downlink transmissions; receive one or more signals comprising: a MAC-CE; a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload; and receive, via a PUSCH, the MAC-CE jointly encoded with an uplink payload.

Another aspect provides one or more apparatuses configured for wireless communications. The one or more apparatuses include means for transmitting a plurality of downlink transmissions; means for receiving one or more signals comprising: a MAC-CE; a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload; and means for receiving, via a PUSCH, the MAC-CE jointly encoded with an uplink payload.

Another aspect provides one or more non-transitory computer-readable media. The one or more non-transitory computer-readable media include executable instructions that, when executed by one or more processors of one or more apparatuses, cause the one or more apparatuses to transmit a plurality of downlink transmissions; receive one or more signals comprising: a MAC-CE; a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload; and receive, via a PUSCH, the MAC-CE jointly encoded with an uplink payload.

In some examples of the methods, apparatuses, and non-transitory computer-readable media described herein, the MAC-CE comprises the second HARQ-ACK part without the first HARQ-ACK part.

In some examples of the methods, apparatuses, and non-transitory computer-readable media described herein, receiving the one or more signals comprises receiving, via a PUCCH, the first HARQ-ACK part.

In some examples of the methods, apparatuses, and non-transitory computer-readable media described herein, the PUCCH and the PUSCH overlap in a time domain.

In some examples of the methods, apparatuses, and non-transitory computer-readable media described herein, a time period associated with the PUSCH is later in time than a time period associated with the PUCCH.

In some examples of the methods, apparatuses, and non-transitory computer-readable media described herein, receiving the first HARQ-ACK part comprises receiving each of a plurality of first HARQ-ACK parts, including the first HARQ-ACK part, via a respective PUCCH; the second HARQ-ACK part is one of a plurality of second HARQ-ACK parts pending reception by the network entity; and each second HARQ-ACK part is associated with a respective first HARQ-ACK part of the plurality of first HARQ-ACK parts.

In some examples of the methods, apparatuses, and non-transitory computer-readable media described herein, the MAC-CE comprises each second HARQ-ACK part of the plurality of second HARQ-ACK parts.

In some examples of the methods, apparatuses, and non-transitory computer-readable media described herein, the MAC-CE further comprises, for each second HARQ-ACK part of the plurality of second HARQ-ACK parts, a respective indication of a respective time period when the associated first HARQ-ACK part was transmitted.

In some examples of the methods, apparatuses, and non-transitory computer-readable media described herein, the MAC-CE further comprises an indication of an order associated with the plurality of second HARQ-ACK parts.

In some examples of the methods, apparatuses, and non-transitory computer-readable media described herein, the second HARQ-ACK part is associated with the first HARQ-ACK part; and the first HARQ-ACK part is received latest in time among the plurality of first HARQ-ACK parts.

In some examples of the methods, apparatuses, and non-transitory computer-readable media described herein, the MAC-CE comprises a subset of the plurality of second HARQ-ACK parts; and the subset comprises at least the second HARQ-ACK part.

Some examples of the methods, apparatuses, and non-transitory computer-readable media described herein may further include operations, features, means, or instructions for transmitting signaling configuring a number of second HARQ-ACK parts to be included in the subset of the plurality of second HARQ-ACK parts.

In some examples of the methods, apparatuses, and non-transitory computer-readable media described herein, the MAC-CE further comprises an indication of an order associated with the subset of the plurality of second HARQ-ACK parts.

In some examples of the methods, apparatuses, and non-transitory computer-readable media described herein, the MAC-CE comprises the first HARQ-ACK part and the second HARQ-ACK part.

In some examples of the methods, apparatuses, and non-transitory computer-readable media described herein, a first field of the MAC-CE comprises the first HARQ-ACK part; and one or more other fields of the MAC-CE comprise at least the second HARQ-ACK part.

Some examples of the methods, apparatuses, and non-transitory computer-readable media described herein may further include operations, features, means, or instructions for transmitting signaling configuring a UE to include the first HARQ-ACK part in the first field of the MAC-CE and the second HARQ-ACK part in the one or more other fields of the MAC-CE.

In some examples of the methods, apparatuses, and non-transitory computer-readable media described herein, the first field indicates a size of at least one of the one or more other fields of the MAC-CE.

In some examples of the methods, apparatuses, and non-transitory computer-readable media described herein, the MAC-CE comprises the first HARQ-ACK part without the second HARQ-ACK part.

In some examples of the methods, apparatuses, and non-transitory computer-readable media described herein, the respective HARQ feedback for each downlink transmission of the plurality of downlink transmissions comprises respective ACK feedback for each downlink transmission of the plurality of downlink transmissions.

Some examples of the methods, apparatuses, and non-transitory computer-readable media described herein may further include operations, features, means, or instructions for transmitting a request to include the first HARQ-ACK part and the second HARQ-ACK part in the MAC-CE.

In some examples of the methods, apparatuses, and non-transitory computer-readable media described herein, transmitting the request comprises transmitting DCI scheduling the PUSCH, the DCI comprising the request.

Some examples of the methods, apparatuses, and non-transitory computer-readable media described herein may further include operations, features, means, or instructions for transmitting a request to include the second HARQ-ACK part in the MAC-CE without including the first HARQ-ACK part in the MAC-CE.

Some examples of the methods, apparatuses, and non-transitory computer-readable media described herein may further include operations, features, means, or instructions for transmitting DCI scheduling the PUSCH and comprising an indication that the first HARQ-ACK part was successfully decoded; and block 1510 includes receiving, via a PUCCH, the first HARQ-ACK part.

In some examples of the methods, apparatuses, and non-transitory computer-readable media described herein, transmitting the request comprises transmitting DCI scheduling the PUSCH, the DCI comprising the request.

Some examples of the methods, apparatuses, and non-transitory computer-readable media described herein may further include operations, features, means, or instructions for transmitting DCI scheduling the PUSCH and comprising an indication that the first HARQ-ACK part was not successfully decoded; and block 1510 includes receiving, via a PUCCH, the first HARQ-ACK part.

In some examples of the methods, apparatuses, and non-transitory computer-readable media described herein, the MAC-CE comprises the HARQ-ACK payload without the first HARQ-ACK part and without the second HARQ-ACK part.

In some examples of the methods, apparatuses, and non-transitory computer-readable media described herein, the MAC-CE comprises the first HARQ-ACK part and the second HARQ-ACK part.

In some examples of the methods, apparatuses, and non-transitory computer-readable media described herein, the MAC-CE comprises the second HARQ-ACK part without the first HARQ-ACK part.

Some examples of the methods, apparatuses, and non-transitory computer-readable media described herein may further include operations, features, means, or instructions for receiving a re-transmission of the first HARQ-ACK part, wherein the first HARQ-ACK part is jointly encoded with UCI multiplexed on the PUSCH.

In some examples of the methods, apparatuses, and non-transitory computer-readable media described herein, a size of the second HARQ-ACK part is a function of the first HARQ-ACK part.

In some examples of the methods, apparatuses, and non-transitory computer-readable media described herein, a size of the first HARQ-ACK part is fixed.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for communications in a network between a network entity and a UE for communicating two part hybrid automatic repeat request acknowledgement (HARQ-ACK) feedback.

FIG. 6 depicts an example of forming two HARQ-ACK parts for a HARQ-ACK payload.

FIGS. 7A and 7B depict example formation of two HARQ-ACK parts for a HARQ-ACK payload based one or more rules.

FIG. 8 depicts a process flow for communications in a network between a network entity and a UE for communicating HARQ-ACK feedback via a medium access control (MAC) control element (MAC-CE).

FIG. 9 depicts a process flow for communications in a network between a network entity and a UE for communicating two part HARQ-ACK feedback using a MAC-CE including a second HARQ-ACK part without including a corresponding first HARQ-ACK part.

FIG. 10 depicts a process flow for communications in a network between a network entity and a UE for communicating two part HARQ-ACK feedback using a MAC-CE including one or more second HARQ-ACK parts.

FIG. 11 depicts a process flow for communications in a network between a network entity and a UE for communicating two part HARQ-ACK feedback using a MAC-CE including both a first HARQ-ACK part and a corresponding second HARQ-ACK part.

FIG. 12 depicts a process flow for communications in a network between a network entity and a UE for communicating two part HARQ-ACK feedback using a MAC-CE including a first HARQ-ACK part without including a corresponding second HARQ-ACK part.

FIG. 13 depicts a process flow for communications in a network between a network entity and a UE communicating two part HARQ-ACK feedback where the network entity fails to decode a first HARQ-ACK part.

FIG. 14 depicts a method for wireless communications.

FIG. 15 depicts another method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for communicating two part hybrid automatic repeat request (HARQ) acknowledgement (HARQ-ACK) feedback. For example, a HARQ-ACK payload may include HARQ-ACK feedback for multiple transmissions. A receiver, intended to receive transmissions associated with the HARQ-ACK feedback, may apply compression to the payload to form a first compressed HARQ-ACK part (simply referred to herein as a “first HARQ-ACK part”) and, in some cases, a second compressed HARQ-ACK part (simply referred to herein as a “second HARQ-ACK part”). According to certain aspects described herein, a medium access control (MAC) control element (MAC-CE) may be leveraged by the receiver to communicate the two part HARQ-ACK feedback between a transmitter and the receiver. For example, different signaling designs described herein may enable the receiver to use the MAC-CE to transmit only the first HARQ-ACK part, only the second HARQ-ACK part, both the first and second HARQ-ACK parts, or the HARQ-ACK payload itself.

As used herein, the phrase referring to “HARQ-ACK feedback” may refer to acknowledgment (ACK) feedback only, negative ACK (NACK) feedback only, or ACK feedback and NACK feedback associated with one or more data packets. More specifically, “HARQ-ACK feedback” may include ACK feedback indicating that one or more data packets were successfully received and decoded, NACK feedback indicating that one or more data packets were not successfully received and/or decoded, or both ACK and NACK feedback for multiple downlink data packets (e.g., ACK or NACK feedback for each data packet).

Further, as used herein, the term “transmitter” may be used to refer to an entity that transmits data packets to a receiver, and receives HARQ-ACK feedback in response to transmitting the data packets (e.g., a transmitter/feedback receiver). The term “receiver” may be used to refer to an entity that is intended to receive the data packets and generates HARQ-ACK feedback associated with the data packets (e.g., a receiver/feedback transmitter).

HARQ is a method for enhancing communication performance through the retransmission of data. HARQ combines error correction and automatic repeat requests, allowing a receiver to request retransmission of lost or corrupted data packets (e.g., a data packet is a formatted unit of data communicated over a network, generally including a header and a payload).

As an illustrative example, prior to transmission, a transmitter may apply an error correcting code (e.g., such as turbo codes, low-density parity-check (LDPC), etc.) to data intended for a receiver. This encoding may add redundancy (e.g., redundant bits to the payload), allowing the receiver to detect and correct errors that may occur during transmission. Further, a cyclic redundancy check (CRC) algorithm may be used to generate a checksum, which is a fixed-size value based on the encoded data being transmitted, and append this checksum to the encoded data. The encoded data along with the checksum may form a complete data packet, which is then transmitted over a wireless channel. After receiving the data packet, the receiver may use the same CRC algorithm to calculate a checksum based on the received data and compare this calculated checksum with the received checksum.

In some cases, the calculated checksum and the received checksum may match, indicating that the data was likely transmitted without significant errors. Accordingly, the receiver may decode the received data and transmit an acknowledgement (ACK) to the transmitter confirming that the transmitted data packet was received successfully and without errors. The ACK may serve as feedback to the transmitter, indicating that the transmitter may proceed with transmitting a next data packet, as the previous one has been successfully received and decoded.

In some other cases, the calculated checksum and the received checksum may not match, suggesting that an error may have occurred during transmission. The receiver may attempt to correct the error using the redundant bits (e.g., added based on the error correcting code). The receiver may transmit an ACK to the transmitter if the error is able to be corrected and the receiver is able to successfully decode the received data. Otherwise, the receiver may transmit a NACK indicating that the transmitted data packet was not received successfully and contains errors that could not be corrected. The NACK may serve as feedback to the transmitter indicating that the particular packet needs to be re-transmitted. Upon receiving the NACK, the transmitter may re-transmit the data to the receiver. In some cases, this re-transmission may include additional error correcting coding to help improve the chances of successful reception and decoding at the receiver.

Although the example describes a scenario where the receiver successfully receives the transmitted data packet, in some other cases, the receiver may fail to detect and receive the data packet. As such, the data packet may be lost, and the receiver may transmit a NACK indicating that the transmitted data packet was not received successfully. The NACK may prompt the transmitter to re-transmit the data.

While HARQ may help to enhance communication reliability, especially in noisy and/or unstable communication environments, its feedback mechanism may consume considerable resources (e.g., time-frequency resources). For example, in cases where data packets are frequently lost and/or corrupted and require re-transmission, the channel may be repeatedly used for both HARQ-ACK feedback and re-transmission of the same data resulting in increased resource consumption. Accordingly, strategies for optimizing resource use may be desired.

Some approaches may utilize compression techniques to help reduce the resource overhead associated with HARQ-ACK feedback. For example, a HARQ-ACK payload may include ACK/NACK feedback for multiple downlink transmissions (e.g., respective ACK/NACK feedback for each downlink transmission) intended for a receiver (e.g., transmitted to the receiver by a transmitter). Prior to transmission of the HARQ-ACK payload, the receiver may apply compression to the payload to form a first (compressed) HARQ-ACK part and, in some cases, a second (compressed) HARQ-ACK part. In certain aspects, the receiver may use lossless compression, or a compression rate that achieves the best possible compression (e.g., reduction of the payload) without any loss of information or distortion (e.g., achieve optimal lossless compression or entropy). The first HARQ-ACK part may have a fixed size, while a size of the second HARQ-ACK part may be a function of a codepoint (e.g., a payload) of the first HARQ-ACK part. In the simplest form of lossless compression, the first HARQ-ACK part may include a single bit indicating whether the HARQ-ACK feedback includes ACK feedback for all downlink transmissions or not. If the single bit indicates that the HARQ-ACK feedback includes only ACK feedback, then the second HARQ-ACK part may not be formed. Otherwise, the second HARQ-ACK part may be formed to indicate the respective ACK/NACK feedback associated with each of the downlink transmissions. The receiver may separately encode and transmit each HARQ-ACK part that is formed. Further, a transmitter may separately decode each HARQ-ACK part that is received (e.g., decode the first HARQ-ACK part prior to decoding the second HARQ-ACK part). As used herein, “encoding” may refer to converting data for transmission (e.g., a HARQ-ACK part, in some cases) into a format suitable for wireless transmission over a communications channel. In certain aspects, “encoding” may involve the use of modulation and coding schemes to efficiently transmit the data over the communications channel. “Modulation” refers to a process of changing the characteristics of a carrier wave, such as amplitude, frequency, and/or phase, to encode the data. “Coding schemes” refer to methods that may be used to encode the data before transmission to help ensure its accurate delivery, such as by adding redundancy to the data. Adding redundancy to the data prior to transmission may help to enhance the reliability of the data transmission, especially over a noisy and/or error-prone communications channel. Example channel encoders may include a polar encoder, a convolutional encoder, a turbo encoder, a low-density parity check (LDPC) encoder, and/or the like.

The use of two part HARQ-ACK feedback may help to reduce transmission overhead, improving efficiency in wireless communication environments. For example, by compressing a HARQ-ACK payload into a first HARQ-ACK part and, in some cases, a second HARQ-ACK part, the average size of the data packets (e.g., the first HARQ-ACK part and, in some cases, the second HARQ-ACK part) sent over the air may be reduced, thereby decreasing the time and the bandwidth required for transmission.

To realize such benefits, certain aspects of the present disclosure provide signaling designs used to support and facilitate the transmission of two part HARQ-ACK feedback. Certain aspects of the signaling designs described herein may utilize a MAC-CE for transmission of the two part HARQ-ACK feedback. For example, the MAC-CE may be used to transmit only a first HARQ-ACK part associated with a HARQ-ACK payload, only a second HARQ-ACK part associated with the HARQ-ACK payload, both the first and second HARQ-ACK parts associated with the HARQ-ACK payload, or the HARQ-ACK payload itself.

As used herein, a MAC-CE is a special type of MAC layer structure used to carry control information, such as HARQ-ACK feedback. A MAC-CE may be communicated between a transmitter and a receiver as part of a transport block (TB). For example, a MAC protocol data unit (PDU) may be packaged as a TB and communicated between a transmitter and a receiver. The MAC PDU may include one or more MAC service data units (SDUs) and/or MAC-CEs. A MAC-CE may be jointly coded with MAC SDU(s) and transmitted as part of a TB. The length of a MAC-CE may not be fixed and instead may vary based on the specific type of control information being transmitted and/or the requirements of the communications environment.

As described herein, the variable length of the MAC-CE may make the MAC-CE a good candidate for transmitting two part HARQ-ACK feedback. For example, due to the variable size of the second HARQ-ACK part of a HARQ-ACK payload, the variable length of the MAC-CE may be useful for transmitting the two part HARQ-ACK feedback. The MAC-CE may facilitate the transmission of the two part HARQ-ACK feedback while optimizing resource usage to thereby help minimize overhead and help ensure that only the necessary amount of resources are being used to communicate this feedback.

The signaling designs described herein, utilized to facilitate the transmission of two part HARQ-ACK feedback, may enable improved wireless performance, such as an ability to achieve payload reduction for HARQ-ACK feedback thereby resulting in improved bandwidth utilization, lower latency, and increased resource efficiency. For example, based on reducing the transmission overhead, the available bandwidth may be used more effectively, allowing for higher data rates. Additionally, the time required to transmit compressed HARQ-ACK feedback compared to non-compressed HARQ-ACK feedback may be less, thereby leading to improved overall latency in the communication process. Further, the combination of compressed/smaller average payload and reduced overhead may reduce resource consumption in wireless communication environments, leading to enhanced communications performance, especially in bandwidth-constrained environments.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

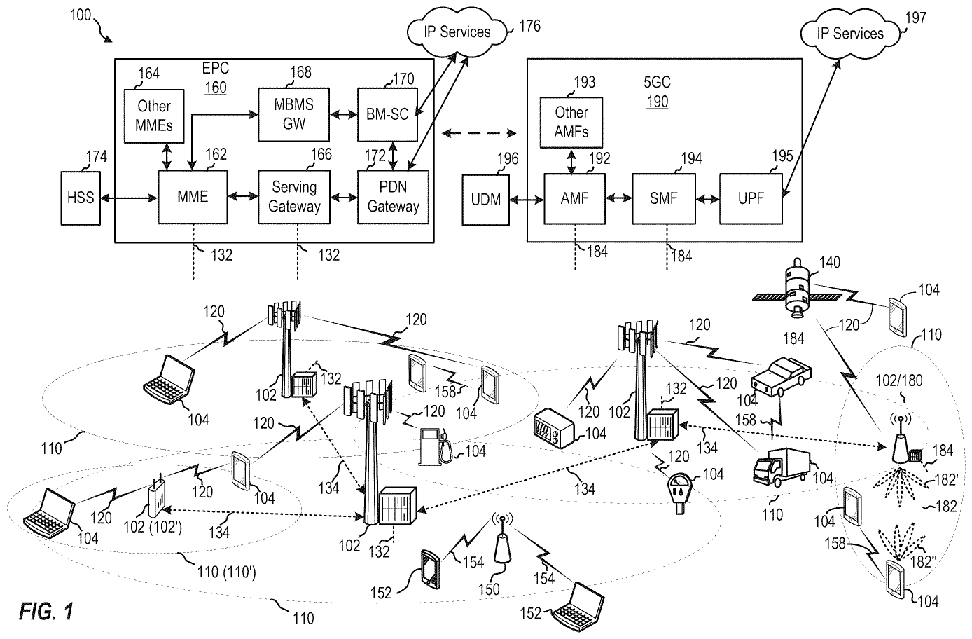

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IOT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

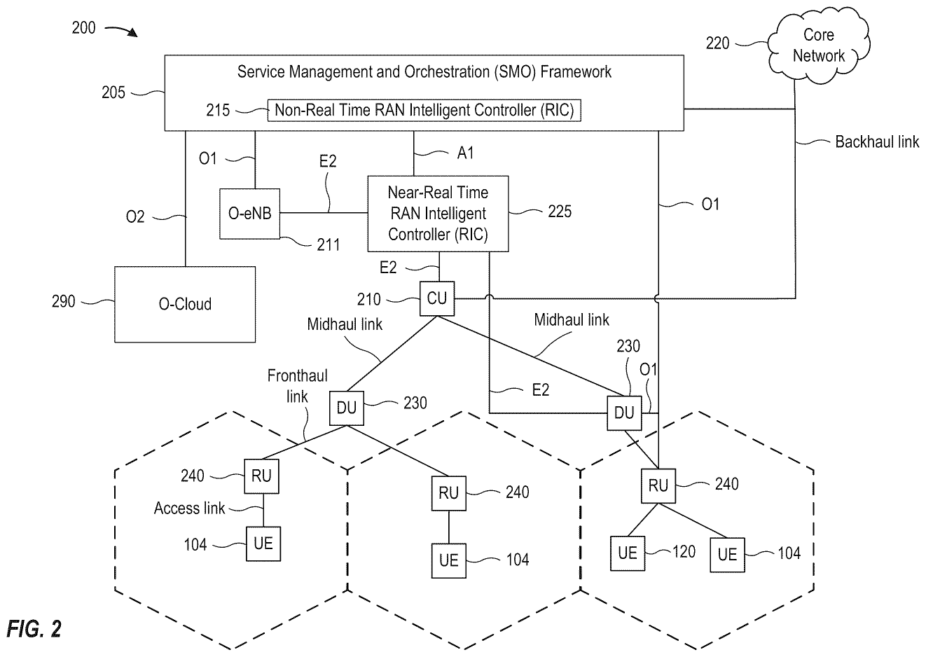

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

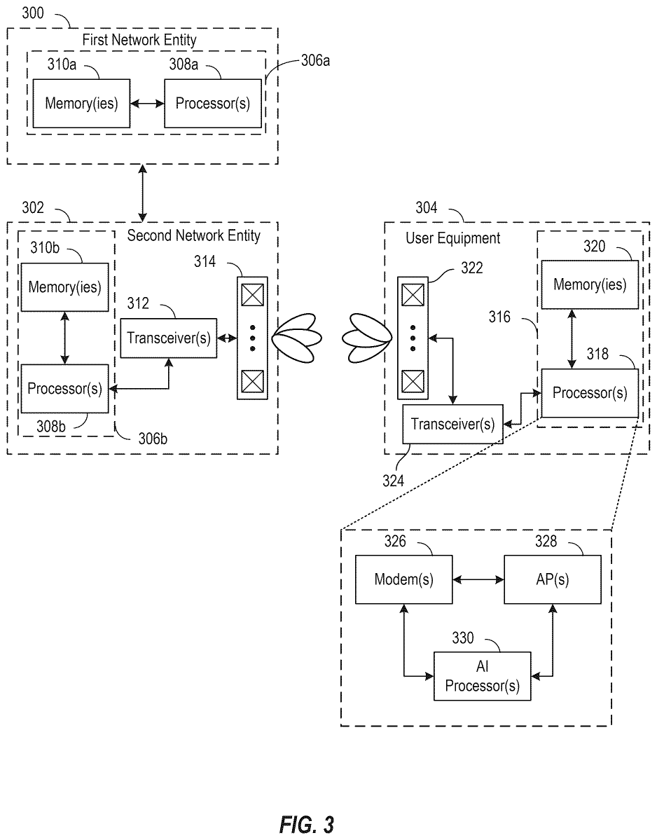

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as transmitting, transmitting, obtaining, or receiving various types of data associated with the methods described herein. In these contexts, “transmitting” or “transmitting” may refer to various mechanisms of outputting data, such as outputting data from a processing system, one or more memories, one or more transceivers, one or more antennas, and/or other aspects described herein. For example, “transmitting” or “transmitting” by a device may include transmitting (such as wirelessly, via a wired connection, or both) to a recipient directly or via another device. As another example, “transmitting” or “transmitting” may include transmitting internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include transmitting, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

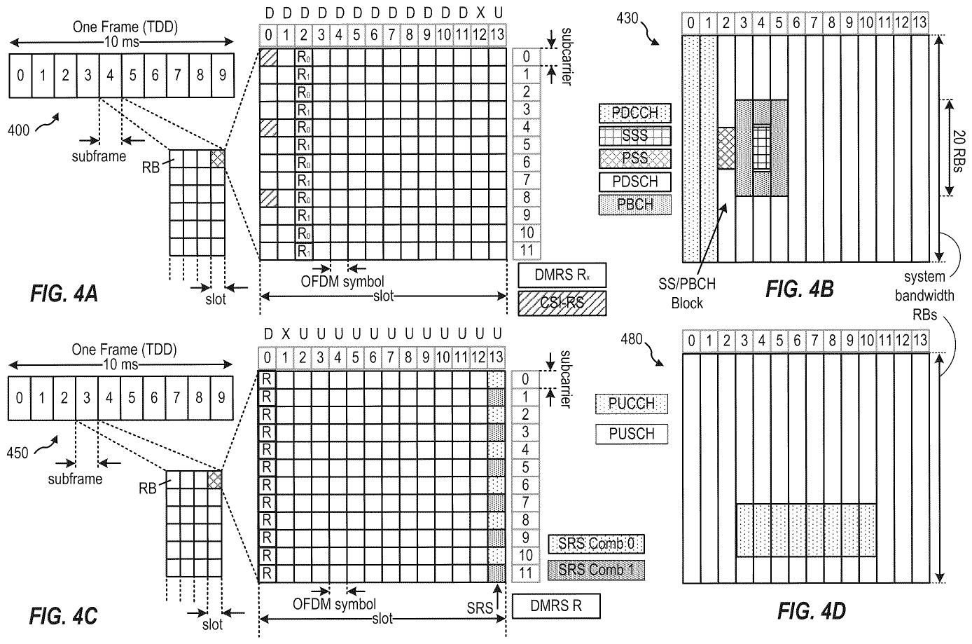

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Two Part HARQ-ACK Feedback

Wireless communications may be unreliable at times. Techniques, such as HARQ, may help to recover transmission errors by allowing an intended receiver of a transmitted data packet to indicate, to a transmitter of the transmitted data packet, whether the transmitted data packet was received and decoded successfully. As described herein, the receiver may transmit an ACK when the receiver receives and is able to correctly decode the received data, and may transmit a NACK when the receiver does not receive and/or is unable to correctly decode the data. A NACK may prompt the transmitter to re-transmit the data, with the hope that the re-transmitted data may be successfully received and correctly decoded at the receiver.

In some cases, a receiver may need to provide HARQ-ACK feedback (e.g., ACKs and/or NACKs) for multiple data packets at a same time (e.g., simultaneously). The receiver may transmit such HARQ-ACK feedback according to a HARQ-ACK codebook. Specifically, a HARQ-ACK codebook is a format for a sequence of bits to simultaneously signal multiple HARQ ACKs and/or NACKs to a transmitter. A HARQ-ACK codebook may allow a receiver to multiplex HARQ ACKs and/or NACKs from multiple slots, carriers, TBs, and/or code block groups (CBGs) within a single PUCCH or PUSCH transmission. The 3GPP specification defines three types of HARQ-ACK codebooks including (1) a type 1 HARQ-ACK codebook, (2) a type 2 HARQ-ACK codebook, and (3) a type 3 HARQ-ACK codebook. HARQ-ACK codebook types 1, 2, and 3 may differentiate based on their dynamic nature, with type 1 being a static codebook, type 2 being dynamic and adapting to a number of downlink (e.g., PDSCH) transmissions requiring feedback, and type 3 being a “one-shot” codebook used for situations where only a single feedback is needed, generally resulting in lower overhead but potentially less flexibility.

The size of a HARQ-ACK codebook may be represented by N bits, where N defines a number of distinct feedback messages (or “codepoints”) that may be communicated by a receiver when using the codebook. For example, a number of codepoints associated with a HARQ-ACK codebook consisting of N bits may be equal to 2^{N} codepoints. Each of the 2^{N} codepoints may correspond to a unique feedback message that may be communicated by the receiver. The receiver may use these codepoints to inform the transmitter whether a transmission was successful (e.g., ACK) or whether a retransmission is required (e.g., NACK), and potentially with additional information depending on the system design. For example, a HARQ-ACK codebook represented by three bits (N=3) may include 2^{N}=2³=8 codepoints. These eight codepoints may correspond to different types of ACK or NACK messages that may be communicated by a receiver when using the HARQ-ACK codebook. For example, a first codepoint associated with bits “000” may correspond to an ACK feedback message confirming that the transmitted data packet was received successfully and without errors, a second codepoint associated with bits “001” may correspond to a NACK feedback message requesting re-transmission of a data packet by a transmitter, a third codepoint associated with bits “100” may correspond to an ACK feedback message, similar to the first codepoint, but including additional information, and so on for the remaining five codepoints.

In some cases, such as in scenarios with a low target block error rate (BLER), a number of HARQ-ACK bits, and thus codepoints, associated with a codebook may be reduced. Specifically, in modern wireless communication environment, keeping a BLER below 10% may be important for ensuring reliable data transmission and maintaining an acceptable quality of service (QoS). The low BLER, e.g., a BLER≤10%, may help to ensure that most data blocks are received correctly without needing re-transmission. As such, it may be assumed that a larger number of data packets are successfully received and decoded, and further that the HARQ-ACK feedback consists mostly of ACK feedback. Based on this assumption, a number of HARQ-ACK bits used for HARQ-ACK feedback via a HARQ-ACK codebook may be reduced.

Some approaches may utilize compression techniques, such as lossless compression, to minimize the average HARQ-ACK payload. For example, a HARQ-ACK payload may include ACK/NACK feedback for multiple downlink transmissions (e.g., respective ACK/NACK feedback for each downlink transmission). Prior to transmission of the HARQ-ACK payload, a transmitter may apply compression to the payload to form a first (compressed) HARQ-ACK part and, in some cases, a second (compressed) HARQ-ACK part (simply referred to herein as a “second HARQ-ACK part”). The transmitter may separately encode and transmit, to a receiver, each HARQ-ACK part that is formed.

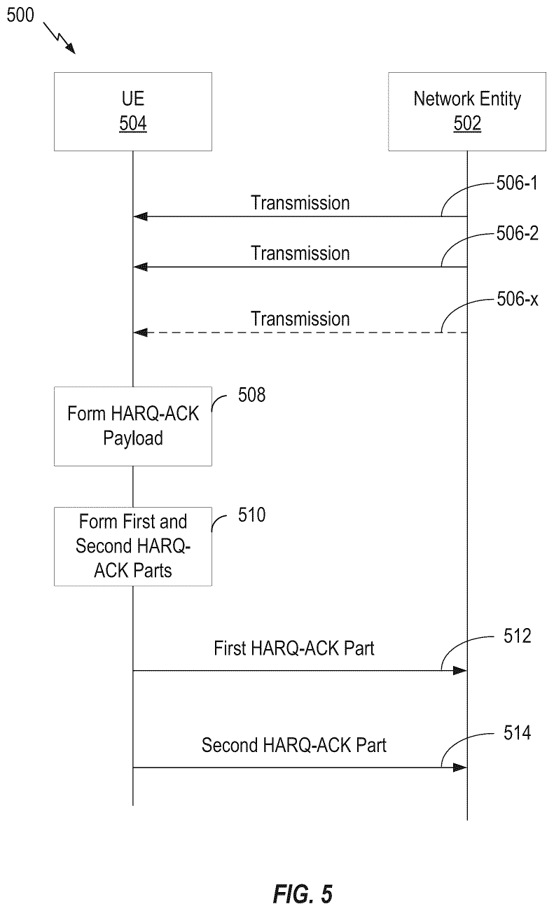

FIG. 5 depicts a process flow 500 for communications in a network between a network entity 502 and a UE 504 for forming and communicating two part HARQ-ACK feedback. In certain aspects, the network entity 502 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 504 may be an example of UE 104 depicted and described with respect to FIG. 1 or the UE 304 depicted and described with respect to FIG. 3. However, in other aspects, UE 504 may be another type of wireless communications device and network entity 502 may be another type of network entity or network node, such as those described herein. Note that any operations or signaling illustrated with dashed lines may indicate that that operation or signaling is an optional or alternative example.

As shown in FIG. 5, process flow 500 may begin with network entity 502 transmitting multiple downlink transmissions to UE 504. For example, a first downlink transmission may be sent, by network entity 502 to UE 504, at 506-1, a second downlink transmission may be sent, by network entity 502 to UE 504, at 506-2, and optionally one or more other downlink transmissions may be sent, by the network entity 502 to UE 504, up to a downlink transmission sent at 506-x (individually referred to herein as “downlink transmission 506” and collectively referred to herein as “downlink transmissions 506”) The downlink transmissions 506 may include multiple code blocks, TBs, and/or CBGs.

UE 504 may be configured to provide HARQ-ACK feedback for each of the downlink transmissions 506 sent to UE 504. For example, process flow 500 may proceed, at 508, with UE 504 forming a HARQ-ACK payload based on the downlink transmissions 506 intended for UE 504. The HARQ-ACK payload may include respective ACK/NACK bits for each downlink transmission 506 sent to UE 504, from network entity 502. For example, in cases where three downlink transmissions 506 are sent, by network entity 502 to UE 504, the HARQ-ACK payload may include one or more bits indicating ACK/NACK feedback for the first downlink transmission 506, one or more bits indicating ACK/NACK feedback for the second downlink transmission 506, and one or more bits indicating ACK/NACK feedback for the third downlink transmission 506. In certain aspects, different ACK/NACK bits of the HARQ-ACK payload may correspond to different PDSCHs (e.g., scheduled at different slots/sub-slots or on different component carriers (CCs)/serving cells), may correspond to different TBs (e.g., each PDSCH may contain one or two TBs), may correspond to different CBGs (e.g., each TB may contain multiple CBGs), may correspond to different CBs (each TB or each CBG may contain multiple CBs), or the like.

To reduce the size of the HARQ-ACK payload, at 510, UE 504 may form a first HARQ-ACK part and a second HARQ-ACK part, where the first and second HARQ-ACK parts are associated with the HARQ-ACK payload. The first HARQ-ACK part may have a fixed size, while a size of the second HARQ-ACK part may be a function of the indicated codepoint (e.g., a payload) of the first HARQ-ACK part. In certain aspects, UE 504 may use lossless compression, at 510, to form the first and second HARQ-ACK parts from the HARQ-ACK payload. For example, UE 504 may use a compression rate that achieves the best possible compression (e.g., reduction of the payload) without any loss of information or distortion (e.g., achieve optimal lossless compression or entropy).

In certain aspects, UE 504 may transmit, to network entity 502, a message indicating that it supports forming two part HARQ-ACK feedback for a HARQ-ACK payload.

In process flow 500 FIG. 5, UE 504 may separately encode and transmit the first and second HARQ-ACK parts. For example, UE 504 may encode the first HARQ-ACK part and transmit, to network entity 502, the first HARQ-ACK part at 512. Subsequently, UE 504 may encode the second HARQ-ACK part and transmit, to network entity 502, the encoded second HARQ-ACK part at 514. Network entity 502 may separately receive and decode the first and second HARQ-ACK parts. Based on the decoding, network entity 502 may determine whether one or more of the downlink transmissions need to be re-transmitted. For example, the second HARQ-ACK part may include ACK feedback for the downlink transmission sent at 506-1 and NACK feedback for the downlink transmission sent at 506-2. Based on receiving this feedback, network entity 502 may re-transmit the downlink transmission originally sent, to UE 504, at 506-2 (not shown in FIG. 5).

In certain aspects, this procedure for transmitting downlink transmission(s), communicating two part HARQ-ACK feedback, and re-transmitting one or more downlink transmissions (e.g., data packets), such as shown in FIG. 5, may continue until all downlink transmission are successfully received and decoded without errors at UE 504. In certain other aspects, this procedure may continue until a termination condition is met (e.g., the expiration of a timer, a maximum number of re-transmissions have been sent for a data packet, etc.).

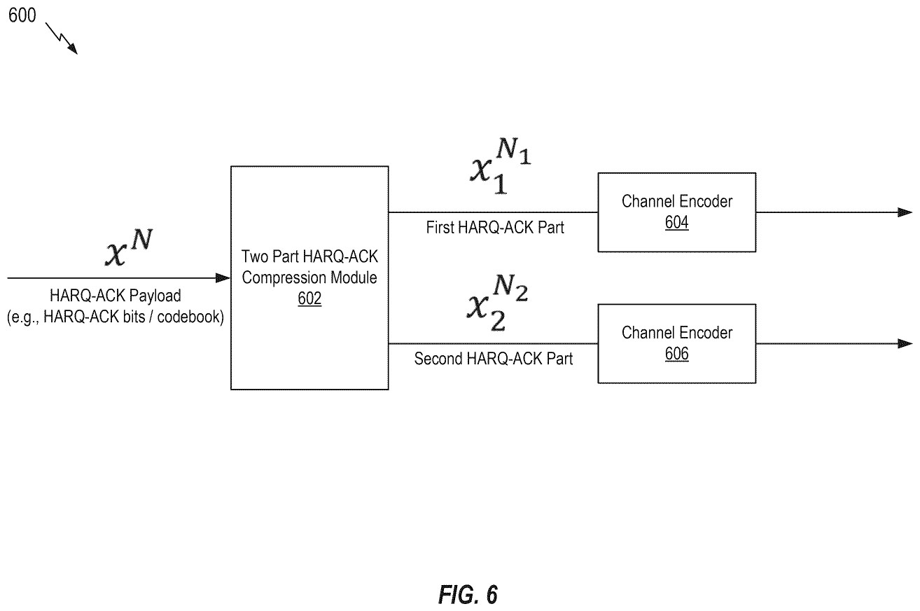

FIG. 6 depicts an example 600 for forming two HARQ-ACK parts from a HARQ-ACK payload, such as the first and second HARQ-ACK parts formed at 510 in FIG. 5. As shown in FIG. 6, a receiver, such as a UE (e.g., UE 104 depicted and described with respect to FIG. 1 or the UE 304 depicted and described with respect to FIG. 3), may generate a HARQ-ACK payload, xN, (e.g., a HARQ-ACK codebook) based on receiving multiple downlink transmissions from a transmitter, such as a network entity (e.g., the BS 102 depicted and described with respect to FIG. 1, the first network entity 300 or the second network entity 302 depicted and described with respect to FIG. 3). A size of an original HARQ-ACK payload generated by the receiver may be N bits. The N bits may also be referred to as a HARQ-ACK payload size.

The HARQ-ACK payload, xN, may be processed by a two part HARQ-ACK compression module 602 to form a first HARQ-ACK part

$${x}_{1}^{{N}_{1}}$$

and a second HARQ-ACK part

$${x}_{2}^{{N}_{2}}$$

In certain aspects, compression module 602 may perform lossless compression to form the first HARQ-ACK part

$${x}_{1}^{{N}_{1}}$$

and the second HARQ-ACK part

$${x}_{2}^{{N}_{2}} .$$

The size of the first HARQ-ACK part

$${x}_{1}^{{N}_{1}}$$

may be N₁ bits, and the size of the second HARQ-ACK part

$${x}_{2}^{{N}_{2}}$$

may be N₂ bits. In certain aspects, the size, N₁, of the first HARQ-ACK part

$${x}_{1}^{{N}_{1}}$$

may be fixed. In certain aspects, the size, N₁, of the first HARQ-ACK part

$${x}_{1}^{{N}_{1}}$$

may be a function of the size, N, of the HARQ-ACK payload. For example, the size, N₁, of the first HARQ-ACK part

$${x}_{1}^{{N}_{1}}$$

may be fixed for a given size N of the HARQ-ACK payload. Further, in certain aspects, the size, N₂, of the second HARQ-ACK part

$${x}_{2}^{{N}_{2}}$$

may be a function of the size, N₁, of the first HARQ-ACK part

$${x}_{1}^{{N}_{1}} .$$

Each HARQ-ACK part

$${x}_{1}^{{N}_{1}} and {x}_{2}^{{N}_{2}}$$

may be separately encoded and then transmitted to a receiver, such as the network entity. For example, the first HARQ-ACK part

$${x}_{1}^{{N}_{1}}$$

may be encoded by a channel encoder 604 and then sent to the transmitter (e.g., the network entity). The second HARQ-ACK part

$${x}_{2}^{{N}_{2}}$$

may be encoded by a channel encoder 606 and then sent to the transmitter. Channel encoder 604 and channel encoder 606 may be the same or different channel encoders. Examples of channel encoder 604 and/or channel encoder 606 may include a polar encoder, a convolutional encoder, a turbo encoder, an LDPC encoder, and/or the like. In certain aspects, the first HARQ-ACK part

$${x}_{1}^{{N}_{1}}$$

may be encoded and sent prior in time to the second HARQ-ACK part

$${x}_{2}^{{N}_{2}}$$

being encoded and sent to the transmitter.

In certain aspects, the HARQ-ACK payload may be compressed using error-free compression such that given the HARQ-ACK part

$${x}_{1}^{{N}_{1}} and {x}_{2}^{{N}_{2}} ,$$

the transmitter may be able to determine the original HARQ-ACK payload x^{N} (e.g., based on decoding HARQ-ACK parts

$${x}_{1}^{{N}_{1}} and {x}_{2}^{{N}_{2}} ) .$$

For example, the transmitter (e.g., the network entity) may decode the first HARQ-ACK part

$${x}_{1}^{{N}_{1}}$$

and determine the size, N₂, (e.g., the length) of the second HARQ-ACK part

$${x}_{2}^{{N}_{2}}$$

based on decoding the first HARQ-ACK part

$${x}_{1}^{{N}_{1}} .$$

Further, the transmitter may decode the second HARQ-ACK part

$${x}_{2}^{{N}_{2}}$$

and determine the size, N, of the HARQ-ACK payload x^{N} based on decoding the first HARQ-ACK part

$${x}_{1}^{{N}_{1}}$$

and the second HARQ-ACK part

$${x}_{2}^{{N}_{2}} .$$

In certain aspects, the first HARQ-ACK part

$${x}_{1}^{{N}_{1}}$$

and the second HARQ-ACK part

$${x}_{2}^{{N}_{2}} ,$$

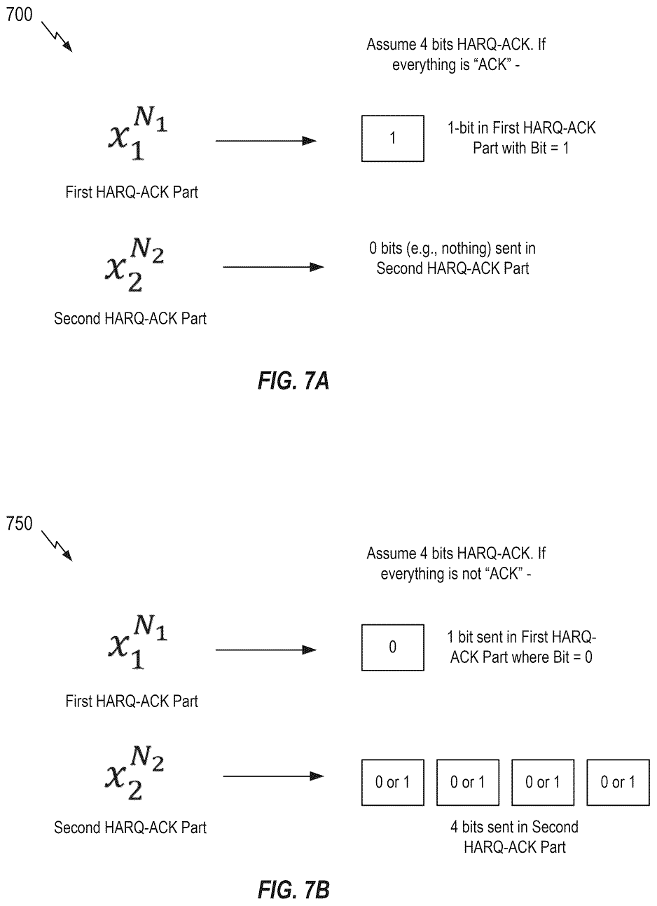

associated with the HARQ-ACK payload x^{N}, may be formed based on one or more rules. FIGS. 7A and 7B depict example formation 700, 750, respectively, of two HARQ-ACK parts, e.g., the first HARQ-ACK part

$${x}_{1}^{{N}_{1}}$$

and the second HARQ-ACK part

$${x}_{2}^{{N}_{2}} ,$$

for a HARQ-ACK payload x^{N} based one or more rules.

As shown in FIG. 7A, in certain aspects where the HARQ-ACK payload x^{N} includes only ACK feedback for multiple transmissions (e.g., all N bits of the HARQ-ACK payload x^{N} are ACKs), then the first HARQ-ACK part

$${x}_{1}^{{N}_{1}}$$

may include a single bit of “1.” Further, the second HARQ-ACK part

$${x}_{2}^{{N}_{2}}$$

may not include any bits; thus, nothing may be included or sent in the second HARQ-ACK part

$${x}_{2}^{{N}_{2}} .$$

The size, N₁, of the first HARQ-ACK part

$${x}_{1}^{{N}_{1}}$$

may be equal to one and the size, N₂, of the second HARQ-ACK part

$${x}_{2}^{{N}_{2}}$$

may be equal to zero.

As an illustrative example, assuming a HARQ-ACK payload x^{N} includes four ACK bits, then the first HARQ-ACK part

$${x}_{1}^{{N}_{1}}$$

may include a single bit set to “1,” and the second HARQ-ACK part

$${x}_{2}^{{N}_{2}}$$

may be empty/include no bits. In some cases, transmission of the first HARQ-ACK part

$${x}_{1}^{{N}_{1}}$$

including the single bit set to “1” occur with a probability of 0.6561 (e.g., for a BLER=10%).

Alternatively, as shown in FIG. 7B, in certain aspects where the HARQ-ACK payload x^{N} includes NACK feedback for at least one transmission among multiple transmissions intended for the receiver (e.g., less than all N bits of the HARQ-ACK payload x^{N} are ACKs), then the first HARQ-ACK part

$${x}_{1}^{{N}_{1}}$$

may include a single bit of “0.” Further, the second HARQ-ACK part

$${x}_{2}^{{N}_{2}}$$

may indicate the original HARQ-ACK payload x^{N}, such that the size, N₂, of the second HARQ-ACK part

$${x}_{2}^{{N}_{2}}$$

may be equal to the size N of the HARQ-ACK payload.

As an illustrative example, assuming a HARQ-ACK payload x^{N} includes four the four bits included in the second HARQ-ACK part

$${x}_{1}^{{N}_{1}}$$

may include a single bit set to “0,” and the second HARQ-ACK part

$${x}_{2}^{{N}_{2}}$$

may include four bits. Each of the four bits included in the second HARQ-ACK part

$${x}_{2}^{{N}_{2}}$$

may be set to “0” or “1” to indicate “ACK” or “NACK” feedback for a specific transmission. Transmission of the first HARQ-ACK part

$${x}_{1}^{{N}_{1}}$$

including the single bit set to “0” and the second HARQ-ACK part

$${x}_{2}^{{N}_{2}}$$

including four bits (e.g., a total of five bits sent) may occur with a probability of 0.3439 (e.g., for a BLER=10%). Therefore, the average number of bits used to communicate the HARQ-ACK feedback may be 1*0.6561+5*0.3439=˜2.4, which is less than the 4 bit HARQ-ACK payload. In particular, only 1 bit is communicated to communicate HARQ-ACK feedback when HARQ-ACK part

$${x}_{1}^{{N}_{1}}$$

has a value of “1” as HARQ-ACK part

$${x}_{2}^{{N}_{2}}$$

is not communicated. Further, 5 bits are communicated to communicate HARQ-ACK feedback when HARQ-ACK part

$${x}_{1}^{{N}_{1}}$$

has a value or “0” as HARQ-ACK part

$${x}_{2}^{{N}_{2}}$$

is communicated using 4 bits. Based on the probabilities given, the average number of bits to communicate such a HARQ-ACK feedback therefore is ˜2.4 bits, which is less than the 4 bits used to communicate the HARQ-ACK payload without encoding.

In the examples shown in FIG. 7A and FIG. 7B, the first HARQ-ACK part

$${x}_{1}^{{N}_{1}}$$

may be a binary AND operation across all N bits of the HARQ-ACK payload x^{N}.

It is noted that example two part HARQ-ACK formations 700, 750 shown in FIGS. 7A and 7B, respectively, illustrate only example two part HARQ-ACK formations, and in some other examples, two part HARQ-ACK feedback may be formed according to one or more different rules.

Different techniques may be considered for communicating two part HARQ-ACK feedback between a receiver (e.g., a UE receiving downlink transmissions) and a transmitter (e.g., a network entity transmitting the downlink transmissions). Each technique may be implemented to facilitate the transmission of the two part HARQ-ACK feedback (or in some cases only the first HARQ-ACK part), such as to reduce a size of the associated HARQ-ACK payload (e.g., for resource efficiency and network bandwidth reduction), and realize one or more advantages associated with the respective technique.

### Aspects Related to Two Part HARQ-ACK Feedback Using a MAC-CE

Aspects described herein improve upon the state of the art by providing signaling designs used to support and facilitate the transmission of HARQ-ACK feedback, such as when it is compressed to form a first HARQ-ACK part and a second HARQ-ACK part. Each of the signaling designs described herein may leverage a MAC-CE for transmission of the two part HARQ-ACK feedback, such as to communicate the feedback for multiple transmissions sent by a transmitter and intended for a receiver. In certain aspects, the two part HARQ-ACK feedback may indicate ACK and/or NACK feedback for multiple downlink transmissions sent by a network entity (e.g., an example transmitter) and intended for a UE (e.g., an example receiver).

For example, in some signaling designs, a MAC-CE may include a first HARQ-ACK part associated with a HARQ-ACK payload without including a corresponding second HARQ-ACK part associated with the HARQ-ACK payload. Thus, the MAC-CE may be used to communicate only the first HARQ-ACK part (e.g., transmit, from the receiver to the transmitter, the first HARQ-ACK part).

In some signaling designs, a MAC-CE may include a second HARQ-ACK part associated with a HARQ-ACK payload without including a corresponding first HARQ-ACK part associated with the HARQ-ACK payload. Thus, the MAC-CE may be used to communicate only the second HARQ-ACK part (e.g., transmit, from the receiver to the transmitter, the second HARQ-ACK part).

In some signaling designs, a MAC-CE may include both a first HARQ-ACK part and a second HARQ-ACK part associated with a HARQ-ACK payload. Thus, the MAC-CE may be used to communicate both the first HARQ-ACK part and the second HARQ-ACK part (e.g., transmit, from the receiver to the transmitter, both the first and second HARQ-ACK parts).

In some signaling designs, a MAC-CE may include a HARQ-ACK payload (e.g., an original HARQ-ACK codebook without compression) without including a first HARQ-ACK part and a second HARQ-ACK part associated with the HARQ-ACK payload. Thus, the MAC-CE may be used to communicate the HARQ-ACK payload (e.g., transmit, from the receiver to the transmitter, the HARQ-ACK payload itself). As described in detail below, a MAC-CE may be used to communicate the HARQ-ACK payload when the transmitter fails to successfully receive and/or decode the first HARQ-ACK part associated with the HARQ-ACK payload (e.g., sent to the transmitter by the receiver).

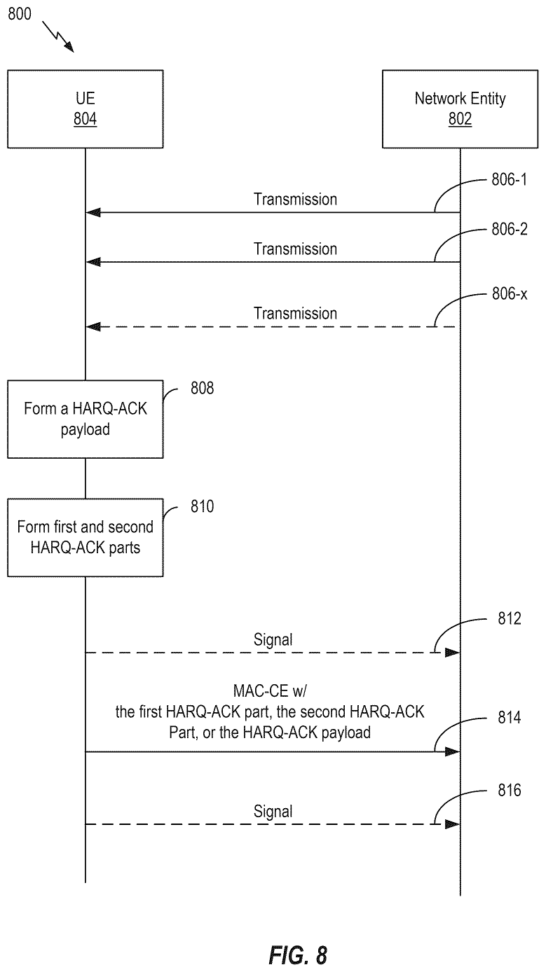

FIG. 8 depicts a process flow 800 for communications in a network between a network entity 802 and a UE 804 for communicating HARQ-ACK feedback via a MAC-CE. In certain aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

Similar to process flow 500 of FIG. 5, process flow 800 shown in FIG. 8 may begin with network entity 802 transmitting multiple downlink transmissions to UE 804. For example, a first downlink transmission may be sent, by network entity 802 to UE 804, at 806-1, a second downlink transmission may be sent, by network entity 802 to UE 804, at 806-2, and optionally one or more other downlink transmissions may be sent, by the network entity 802 to UE 804, up to a downlink transmission sent at 806-x (individually referred to herein as “downlink transmission 806” and collectively referred to herein as “downlink transmissions 806”). The downlink transmissions 806 may include multiple code blocks, TBs, and/or CBGs.

UE 804 may be configured to provide HARQ-ACK feedback for each of the downlink transmissions 806 sent to UE 804. For example, process flow 800 may proceed, at 808, with UE 804 forming a HARQ-ACK payload based on the downlink transmissions 806 intended for UE 804. The HARQ-ACK payload may include respective ACK/NACK bits for each downlink transmission 806 sent to UE 804, from network entity 802.

To reduce the size of the HARQ-ACK payload, at 810, UE 804 may form a first HARQ-ACK part and a second HARQ-ACK part, where the first and second HARQ-ACK parts are associated with the HARQ-ACK payload. The first HARQ-ACK part may have a fixed size, while a size of the second HARQ-ACK part may be a function of the indicated codepoint (e.g., a payload) of the first HARQ-ACK part. In certain aspects, UE 804 may use compression, such as lossless compression, at 810, to form the first and second HARQ-ACK parts from the HARQ-ACK payload.

Process flow 800 may then proceed with UE 804 transmitting one or more signals, such as the signal sent at 814 and optionally the signal(s) sent at 812 and/or 816 shown in FIG. 8. In certain aspects, the signal sent at 814 may comprise a MAC-CE. The MAC-CE may be used to communicate the first HARQ-ACK part only, the second HARQ-ACK part only, both the first HARQ-ACK part and the second HARQ-ACK part, or the HARQ-ACK payload itself, such as to facilitate the communication of HARQ-ACK feedback to network entity 802.

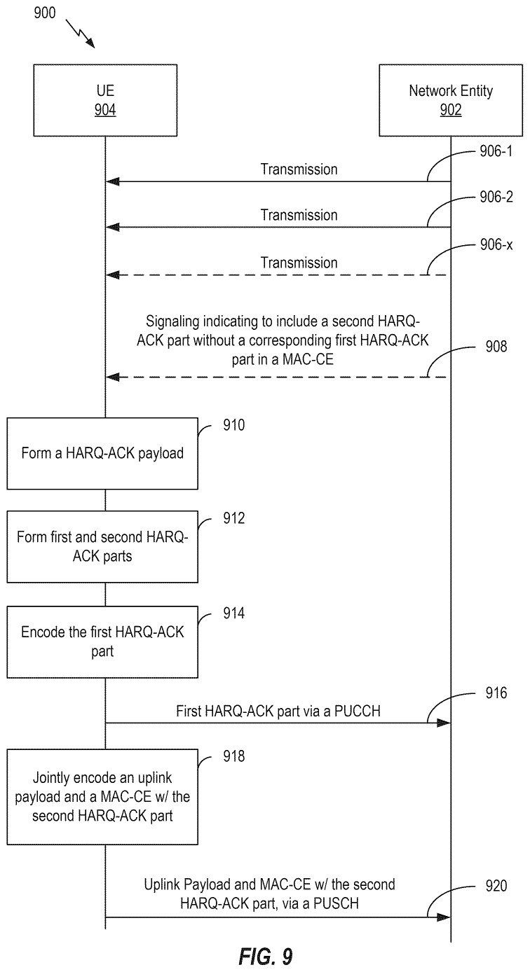

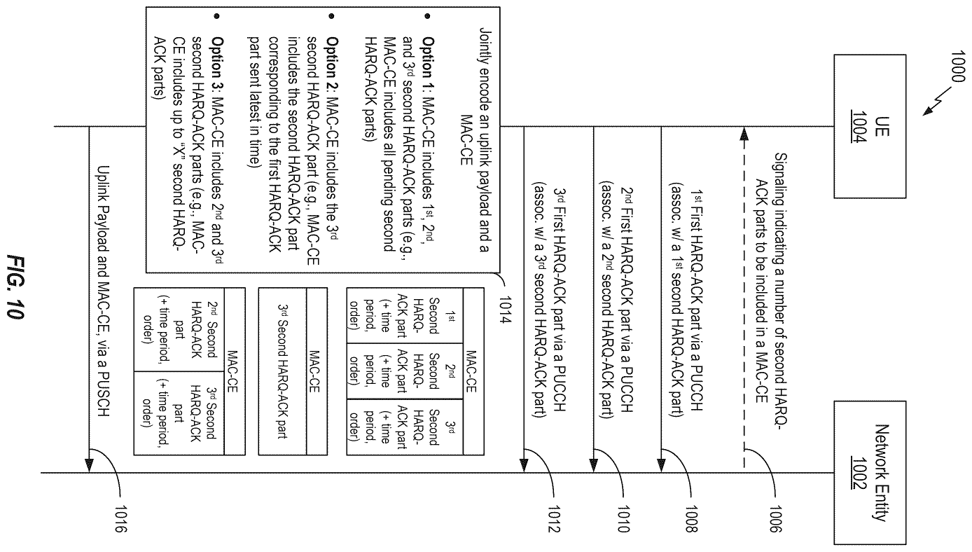

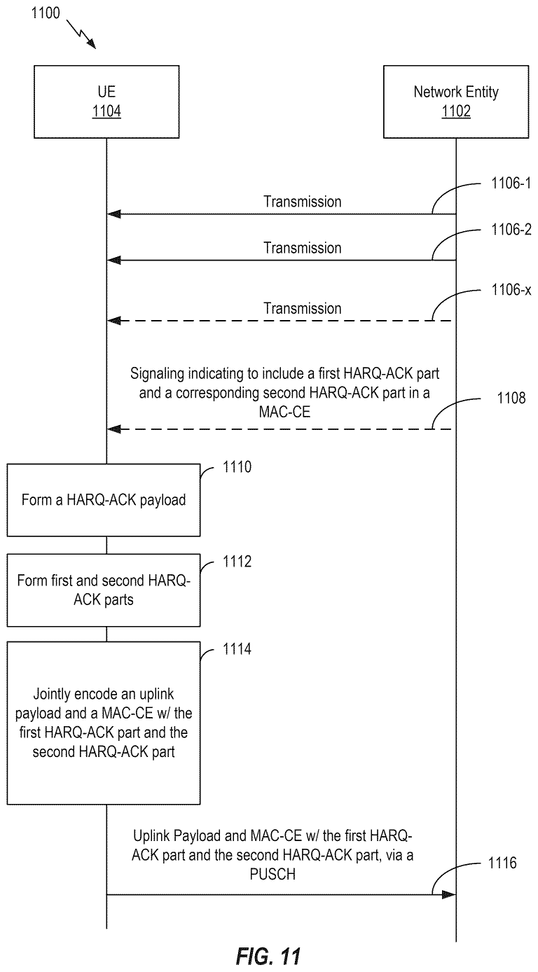

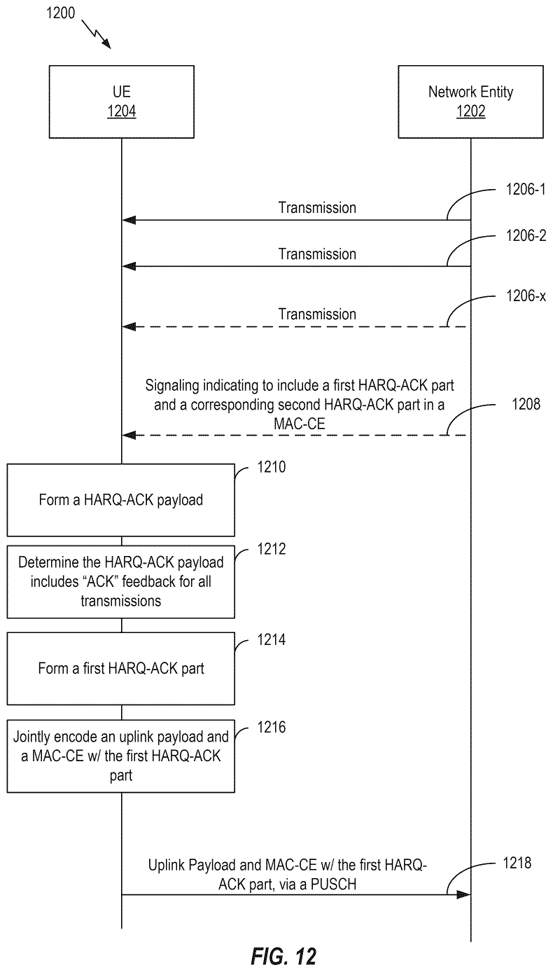

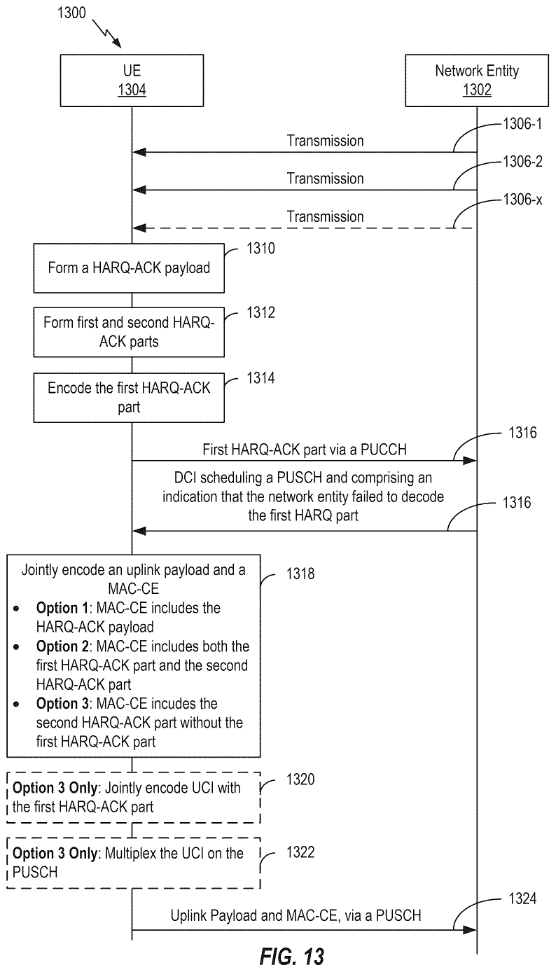

Different signaling designs describing when the MAC-CE is used to communicate a first HARQ-ACK part, a second HARQ-ACK part, or a HARQ-ACK payload are depicted and described in detail below with respect to FIGS. 9-13. In FIGS. 9 and 10, the MAC-CE may include a second HARQ-ACK part without including the first HARQ-ACK part (or the HARQ-ACK payload). For example, the first HARQ-ACK part associated with the HARQ-ACK payload may be sent (e.g., to a network entity, such as network entity 808) via a PUCCH, and the second HARQ-ACK part associated with the HARQ-ACK payload may be sent (e.g., to the network entity) via the MAC-CE. In FIG. 11, the MAC-CE may include a first HARQ-ACK part and a second HARQ-ACK part (without including the HARQ-ACK payload). That is, the first HARQ-ACK part associated with the HARQ-ACK payload and the second HARQ-ACK part associated with the HARQ-ACK payload may be sent (e.g., to the network entity) via the MAC-CE. In FIG. 12, the MAC-CE may include a first HARQ-ACK part without including the second HARQ-ACK part (or the HARQ-ACK payload). That is, the first HARQ-ACK part associated with the HARQ-ACK payload may be sent (e.g., to the network entity) via the MAC-CE, and a second HARQ-ACK part associated with the HARQ-ACK payload may not be sent. This scenario may occur where the HARQ-ACK payload includes only ACK feedback for multiple transmissions, thereby causing the formation of the first HARQ-ACK part with a single bit set to “1” and an empty second HARQ-ACK part (e.g., as depicted and described with respect to FIG. 7A). In FIG. 13, different options are considered for including the first HARQ-ACK part, the second HARQ-ACK part, and/or the HARQ-ACK payload in the MAC-CE based on the network entity failing to successfully receive and/or decode the first HARQ-ACK part sent via a PUCCH (e.g., to the network entity).

As described herein, the length of a MAC-CE may not be fixed and instead may vary based on the specific type of control information being transmitted and/or the requirements of the communications environment. Thus, a MAC-CE may represent a good candidate for transmitting two part HARQ-ACK feedback. Specifically, due to the variable size of the second HARQ-ACK part of a HARQ-ACK payload, the variable length of the MAC-CE may be useful for transmitting the two part HARQ-ACK feedback. The MAC-CE may facilitate the transmission of the two part HARQ-ACK feedback while optimizing resource usage to thereby minimize overhead and help ensure that only the necessary amount of resources are being used to communicate this feedback.

### Example Signaling of Two Part HARQ-ACK Feedback

FIGS. 9-13 depict process flow 900, 1000, 1100, 1200, 1300 for communications in a network between a network entity 902, 1002, 1102, 1202, 1302 and a UE 904, 1004, 1104, 1204, 1304, respectively. In certain aspects, the network entity 902, 1002, 1102, 1202, 1302 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904, 1004, 1104, 1204, 1304 may be an example of UE 104 depicted and described with respect to FIG. 1 or the UE 304 depicted and described with respect to FIG. 3. However, in other aspects, UE 904, 1004, 1104, 1204, 1304 may be another type of wireless communications device and network entity 902, 1002, 1102, 1202, 1302 may be another type of network entity or network node, such as those described herein. Note that any operations or signaling illustrated with dashed lines may indicate that that operation or signaling is an optional or alternative example.

Beginning with FIG. 9, process flow 900 provides a first signaling design for communicating HARQ-ACK feedback via a MAC-CE. As described above, in FIG. 9, the MAC-CE may include a second HARQ-ACK part associated with a HARQ-ACK payload, without including a first HARQ-ACK part associated with the HARQ-ACK payload (or the HARQ-ACK payload itself). For example, the first HARQ-ACK part may be communicated via a PUCCH, and the second HARQ-ACK part may be communicated via the MAC-CE.

Similar to process flow 800 of FIG. 8, process flow 900 shown in FIG. 9 may begin with network entity 902 transmitting multiple downlink transmissions to UE 904. For example, a first downlink transmission may be sent, by network entity 902 to UE 904, at 906-1, a second downlink transmission may be sent, by network entity 902 to UE 904, at 906-2, and optionally one or more other downlink transmissions may be sent, by the network entity 902 to UE 904, up to a downlink transmission sent at 906-x (individually referred to herein as a “downlink transmission 906” and collectively referred to herein as “downlink transmissions 906”). The downlink transmissions 906 may include multiple code blocks, TBs, and/or CBGs.

Optionally, at 908, network entity 902 may transmit, to UE 904, signaling indicating to include a second HARQ-ACK part associated with a HARQ-ACK payload, without including a corresponding first HARQ-ACK part associated with the HARQ-ACK payload, in a MAC-CE. Although FIG. 9 depicts this signaling being sent after receiving the downlink transmissions 906, in some other examples, this signaling may be sent prior to receiving the downlink transmissions 906 and/or later in time than one or more of the other steps shown in FIG. 9.

UE 904 may be configured to provide HARQ-ACK feedback for each of the downlink transmissions 906 sent to UE 904. Accordingly, at 910, UE 904 forms a HARQ-ACK payload based on the downlink transmissions 906 intended for UE 904. The HARQ-ACK payload may include respective ACK/NACK bits for each downlink transmission 906 sent to UE 904, from network entity 902. In this example, NACK bit(s) may be provided for at least one downlink transmission 906 (e.g., the HARQ-ACK payload includes more than just ACK feedback).

To reduce the size of the HARQ-ACK payload, at 912, UE 904 forms a first HARQ-ACK part and a second HARQ-ACK part, where the first and second HARQ-ACK parts are associated with the HARQ-ACK payload. The first HARQ-ACK part may have a fixed size, while a size of the second HARQ-ACK part may be a function of the indicated codepoint (e.g., a payload) of the first HARQ-ACK part. In certain aspects, UE 904 may use compression, such as lossless compression, at 912, to form the first and second HARQ-ACK parts from the HARQ-ACK payload.

At 914, UE 904 encodes the first HARQ-ACK part. More specifically, UE 904 encodes the first HARQ-ACK part separately from the second HARQ-ACK part. At 916, UE 904 transmits, to network entity 902 via a PUCCH, the encoded first HARQ-ACK part. For example, the first HARQ-ACK part may be sent, to network entity 902, as uplink control information (UCI) using a PUCCH resource. In certain aspects, UE 904 encodes and transmits the first HARQ-ACK part separately from the second HARQ-ACK part based on the signaling received at 908.

At 918, UE 904 jointly encodes an uplink payload and a MAC-CE. The MAC-CE may include the second HARQ-ACK part. For example, UE 904 may determine to include the second HARQ-ACK part at part of the MAC-CE payload based on the signaling received at 908. As such, the second HARQ-ACK part may be part of an uplink transport block (e.g., jointly encoded with the uplink payload) (and not part of a UCI that is multiplexed on a PUSCH).

At 920, UE 904 transmits, to network entity 902 via a PUSCH, the MAC-CE (e.g., including only the second HARQ-ACK part) jointly encoded with the uplink payload.

In certain aspects, the PUCCH used to transmit the first HARQ-ACK part and the PUSCH used to transmit the second HARQ-ACK part overlap in a time domain. In certain aspects, a time period associated with the PUSCH used to transmit the second HARQ-ACK part is later in time than a time period associated with the PUCCH used to transmit the first HARQ-ACK part. Accordingly, in certain aspects, this signaling design may provide the flexibility of transmitting the second HARQ-ACK part via a MAC-CE of any PUSCH on any CC that is after, or on, the PUCCH resource (e.g., the PUCCH slot).

Although not shown in FIG. 9, network entity 902 may separately receive and decode the first HARQ-ACK part and the second HARQ-ACK part to determine the HARQ-ACK feedback for downlink transmissions 906, and whether one or more of the downlink transmissions 906 need to be re-transmitted to UE 904.

In certain aspects, a UE my form multiple HARQ-ACK payloads based on receiving multiple downlink transmissions. Thus, multiple first HARQ-ACK parts and multiple second HARQ-ACK parts may be formed and sent to a network entity to provide the network entity with the HARQ-ACK feedback. In certain aspects, one or more of the second HARQ-ACK parts may be included in a MAC-CE that is sent to the network entity. FIG. 10 depicts a process flow 1000 for communications in a network between a network entity 1002 and a UE 1004 for communicating two part HARQ-ACK feedback using a MAC-CE including one or more second HARQ-ACK parts (without including one or more first HARQ-ACK parts or one or more HARQ-ACK payloads prior to compression).

Although not shown in FIG. 10, process flow 1000 may begin with UE 1004 receiving multiple downlink transmissions, forming multiple HARQ-ACK payloads (e.g., multiple HARQ-ACK codebooks), and forming a respective first HARQ-ACK part and a respective second HARQ-ACK part for each HARQ ACK payload generated. As an illustrative example, UE 1004 may generate a first HARQ-ACK payload indicating ACK/NACK feedback for a first set of downlink transmissions, generate a second HARQ-ACK payload indicating ACK/NACK feedback for a second set of downlink transmissions, and generate a third HARQ-ACK payload indicating ACK/NACK feedback for a third set of downlink transmissions. A 1^{st} first HARQ-ACK part and a 1^{st} second HARQ-ACK part may be formed and associated with the first HARQ-ACK payload. A 2^{nd} first HARQ-ACK part and a 2^{nd} second HARQ-ACK part may be formed and associated with the first HARQ-ACK payload. Further, a 3^{rd} first HARQ-ACK part and a 3^{rd} second HARQ-ACK part may be formed and associated with the third HARQ-ACK payload.

As shown in process flow 1000 of FIG. 10, UE 1004 may transmit, to network entity 1002 at 1008, the 1^{st} first HARQ-ACK associated with the first HARQ-ACK payload via a PUCCH. Subsequently, UE 1004 may transmit, to network entity 1002 at 1010, the 2^{nd} first HARQ-ACK associated with the second HARQ-ACK payload via a PUCCH. Subsequently, UE 1004 may transmit, to network entity 1002 at 1012, the 3^{rd} first HARQ-ACK associated with the third HARQ-ACK payload via a PUCCH. As such, UE 1004 may transmit, to network entity 1002, the 1^{st} first HARQ-ACK part prior in time to transmitting the 2^{nd} first HARQ-ACK part and the 3^{rd} first HARQ-ACK part, and transmit the 2^{nd} first HARQ-ACK part prior in time to transmitting the 3^{rd} first HARQ-ACK part.

In certain aspects, UE 1004 may determine to transmit the first HARQ-ACK parts via a PUCCH, instead of using a MAC-CE based on receiving some signaling (e.g., not shown in FIG. 10, but shown at 908 in FIG. 9) indicating that a MAC-CE should include second HARQ-ACK part(s) without including first HARQ-ACK part(s).

After transmitting 1^{st}, 2^{nd}, and 3^{rd} first HARQ-ACK parts, 1^{st}, 2^{nd}, and 3^{rd} second HARQ-ACK parts may be pending transmission. Different rules may be followed to determine which of these HARQ-ACK parts may be included in a MAC-CE subsequently sent to network entity 1002, from UE 1004.

In a first option (“Option 1”) following a first rule, the MAC-CE may include all pending second HARQ-ACK parts. Thus, in the example depicted in FIG. 10, a MAC-CE may include the 1^{st}, 2^{nd}, and 3^{rd} second HARQ-ACK parts. Accordingly, at 1014, UE 1004 jointly encodes an uplink payload and the MAC-CE including the 1^{st}, 2^{nd}, and 3^{rd} second HARQ-ACK parts. At 1016, UE 1004 transmits, to network entity 1002 via a PUSCH, the MAC-CE (e.g., including the 1^{st}, 2^{nd}, and 3^{rd} second HARQ-ACK parts) jointly encoded with the uplink payload.

In certain aspects, the MAC-CE may further include, for each second HARQ-ACK part included in the MAC-CE, a respective indication of a respective time period when the associated first HARQ-ACK part was transmitted. These explicit indications may be provided as new field(s) of the MAC-CE. For example, for the 1^{st} second HARQ-ACK part included in the MAC-CE, the MAC-CE may indicate a first slot index associated with a slot where the 1^{st} first HARQ-ACK part was transmitted from UE 1004 to network entity 1002. For the 2^{nd} second HARQ-ACK part included in the MAC-CE, the MAC-CE may indicate a second slot index associated with a slot where the 2^{nd} first HARQ-ACK part was transmitted from UE 1004 to network entity 1002. Further, for the 3^{rd} second HARQ-ACK part included in the MAC-CE, the MAC-CE may indicate a third slot index associated with a slot where the 3^{rd} first HARQ-ACK part was transmitted from UE 1004 to network entity 1002.

In certain aspects, the MAC-CE may further include an indication of an order associated with the second HARQ-ACK parts included in the MAC-CE. The indication of the order may be included as new field in the MAC-CE. For example, the MAC-CE may indicate that the second HARQ-ACK parts are included in the MAC-CE with the 1^{st} second HARQ-ACK part being first, the 2^{nd} second HARQ-ACK part being second, and the 3^{rd} second HARQ-ACK part being third (e.g., last).

In a second option (“Option 2”) following a second rule, the MAC-CE may include only a single second HARQ-ACK part that is pending transmission and is associated with a first HARQ-ACK part that was transmitted latest in time among the first HARQ-ACK parts that were previously transmitted. For example, in FIG. 10, the MAC-CE may include only the 3^{rd} second HARQ-ACK part because the 3^{rd} second HARQ-ACK part is associated with the 3^{rd} first HARQ-ACK part, which was transmitted latest in time among the 1^{st}, 2^{nd}, and 3^{rd} first HARQ-ACK parts. Because the MAC-CE includes only the 3^{rd} second HARQ-ACK part, the 1^{st} and 2^{nd} pending second HARQ-ACK parts may be dropped. Accordingly, at 1014, UE 1004 jointly encodes an uplink payload and the MAC-CE including only the 3^{rd} second HARQ-ACK part. At 1016, UE 1004 transmits, to network entity 1002 via a PUSCH, the MAC-CE (e.g., including only the 3^{rd} second HARQ-ACK part) jointly encoded with the uplink payload.

In a third option (“Option 3”) following a third rule, the MAC-CE may include a subset of the pending second HARQ-ACK parts. For example, among the pending second HARQ-ACK parts, up to an “X” amount of the pending second HARQ-ACK parts may be included in the MAC-CE. The remaining pending second HARQ-ACK parts may be dropped. For example, in FIG. 10, the MAC-CE may include up to “X” second HARQ-ACK parts, where in this example X=2. Thus, UE 1004 may select two of the three pending second HARQ-ACK parts to include in the MAC-CE. In certain aspects, the selection is performed randomly. In certain aspects, UE 1004 selects the two pending second HARQ-ACK parts that are associated with first HARQ-ACK parts transmitted latest in time. For this example, UE 1004 may select the 2^{nd} second HARQ-ACK part and the 3^{rd} second HARQ-ACK part and include these in the MAC-CE. Thus, the 1^{st} second HARQ-ACK part may be dropped. Accordingly, at 1014, UE 1004 jointly encodes an uplink payload and the MAC-CE including the 2^{nd} and 3^{rd} second HARQ-ACK parts. At 1016, UE 1004 transmits, to network entity 1002 via a PUSCH, the MAC-CE (e.g., including the 2^{nd} and 3^{rd} second HARQ-ACK parts) jointly encoded with the uplink payload.

In certain aspects, the MAC-CE may further include an indication of an order associated with the second HARQ-ACK parts included in the MAC-CE. The indication of the order may be included as new field in the MAC-CE. For example, the MAC-CE may indicate that the second HARQ-ACK parts are included in the MAC-CE with the 2^{nd} second HARQ-ACK part being first and the 3^{rd} second HARQ-ACK part being last.

In certain aspects, the MAC-CE may further include, for each second HARQ-ACK part included in the MAC-CE, a respective indication of a respective time period when the associated first HARQ-ACK part was transmitted.

In certain aspects, UE 1004 may receive signaling indicating a number of pending second HARQ-ACK parts (e.g., the amount X) to include in the MAC-CE. For example, as shown in FIG. 10, optionally at 1006, network entity 1002 may transmit, to UE 1004, signaling indicating a number (e.g., a maximum number) of pending second HARQ-ACK parts to be included in a MAC-CE. As used herein, a second HARQ-ACK part may be referred to as “pending” when its corresponding first HARQ-ACK part has been successfully received and decoded by network entity 1002.

Moving to FIG. 11, process flow 1100 provides another signaling design for communicating HARQ-ACK feedback via a MAC-CE. As described above, in FIG. 11, the MAC-CE may include both a first HARQ-ACK part and a second HARQ-ACK part associated with a HARQ-ACK payload (without including the uncompressed HARQ-ACK payload). For example, the first HARQ-ACK part and the second HARQ-ACK part associated with the HARQ-ACK payload may be communicated via the MAC-CE.

Similar to process flow 800 of FIG. 8 and 900 of FIG. 9, process flow 1100 shown in FIG. 11 may begin with network entity 1102 transmitting multiple downlink transmissions to UE 1104. For example, a first downlink transmission may be sent, by network entity 1102 to UE 1104, at 1106-1, a second downlink transmission may be sent, by network entity 1102 to UE 1104, at 1106-2, and optionally one or more other downlink transmissions may be sent, by the network entity 1102 to UE 1104, up to a downlink transmission sent at 1106-x (individually referred to herein as a “downlink transmission 1106” and collectively referred to herein as “downlink transmissions 1106”). The downlink transmissions 1106 may include multiple code blocks, TBs, and/or CBGs.

Optionally, at 1108, network entity 1102 may transmit, to UE 1104, signaling indicating to include a first HARQ-ACK part and a second HARQ-ACK part associated with a HARQ-ACK payload in a MAC-CE. Although FIG. 11 depicts this signaling being sent after receiving the downlink transmissions 1106, in some other examples, this signaling may be sent prior to receiving the downlink transmissions 1106 and/or later in time than one or more of the other steps shown in FIG. 11.

In certain other aspects, instead of receiving the signaling at 1108, UE 1104 may be configured (e.g., by network entity 1002, such as via radio resource control (RRC) signaling) to include a first HARQ-ACK part and a second HARQ-ACK part associated with a HARQ-ACK payload in a MAC-CE. In certain other aspects, the UE 1004 including a first HARQ-ACK part and a second HARQ-ACK part associated with a HARQ-ACK payload in a MAC-CE may be rule defined in the standards (e.g., in 3GPP specifications).

UE 1104 may be configured to provide HARQ-ACK feedback for each of the downlink transmissions 1106 sent to UE 1104. Accordingly, at 1110, UE 1104 forms a HARQ-ACK payload based on the downlink transmissions 1106 intended for UE 1104. The HARQ-ACK payload may include respective ACK/NACK bits for each downlink transmission 1106 sent to UE 1104, from network entity 1102. In this example, NACK bit(s) may be provided for at least one downlink transmission 1106 (e.g., the HARQ-ACK payload includes more than just ACK feedback).

To reduce the size of the HARQ-ACK payload, at 1112, UE 1104 forms a first HARQ-ACK part and a second HARQ-ACK part, where the first and second HARQ-ACK parts are associated with the HARQ-ACK payload. The first HARQ-ACK part may have a fixed size, while a size of the second HARQ-ACK part may be a function of the indicated codepoint (e.g., a payload) of the first HARQ-ACK part. In certain aspects, UE 1104 may use compression, such as lossless compression, at 1112, to form the first and second HARQ-ACK parts from the HARQ-ACK payload.

At 1114, UE 1104 jointly encodes an uplink payload and a MAC-CE. The MAC-CE may include the first HARQ-ACK part and the second HARQ-ACK part. For example, UE 1104 may determine to include the first HARQ-ACK part and the second HARQ-ACK part as part of the MAC-CE payload based on the signaling received at 1108. As such, the first HARQ-ACK part and the second HARQ-ACK part may be part of an uplink transport block (e.g., jointly encoded with the uplink payload) (and not part of a UCI that is multiplexed on a PUSCH).

In certain aspects, the first HARQ-ACK part may be included in a field in the MAC-CE that is used to determine the size of one or more other fields, such as a field used to convey the second HARQ-ACK part, and in turn, determine the payload size of the MAC-CE.

At 1116, UE 1104 transmits, to network entity 1102 via a PUSCH, the MAC-CE (e.g., including the first HARQ-ACK part and the second HARQ-ACK part) jointly encoded with the uplink payload.

FIG. 12 provides another signaling design for communicating HARQ-ACK feedback via a MAC-CE, where a UE 1204 is configured or signaled to include both a first HARQ-ACK part and a second HARQ-ACK part, associated with a HARQ-ACK payload, in the MAC-CE. However, different from FIG. 11, in FIG. 12, the HARQ-ACK payload may include only ACK feedback for the multiple downlink transmissions. Signaling for conveying this ACK feedback to a network entity 1202 is provided in FIG. 12.

Steps 1206-1, 1206-2, 1206-x, 1208, and 1210 shown in FIG. 12 may be similar to steps 1106-1, 1106-2, 1106-x, 1108, and 1110 shown in FIG. 11. However, different from FIG. 12, the HARQ-ACK payload formed at 1210 may include only ACK feedback.

At 1212, UE 1204 determines that the HARQ-ACK payload included only “ACK” feedback for the transmissions at 1206-1, 1206-2, and up to 1206-x, and based on this determination, at 1214, forms a first HARQ-ACK part. The first HARQ-ACK part may be formed to include only a single bit set to “1” (e.g., similar to the first HARQ-

ACK part formed in FIG. 7A). Although not shown, UE 1204 may form the second HARQ-ACK part, however, the second HARQ-ACK pay may be empty/include not bits.

At 1216, UE 1204 jointly encodes an uplink payload and a MAC-CE. The MAC-CE may include only the first HARQ-ACK part. As such, the first HARQ-ACK part may be part of an uplink transport block (e.g., jointly encoded with the uplink payload) (and not part of a UCI that is multiplexed on a PUSCH).

At 1218, UE 1204 transmits, to network entity 1202 via a PUSCH, the MAC-CE (e.g., including the first HARQ-ACK part only) jointly encoded with the uplink payload.

Moving to FIG. 13, process flow 1300 provides another signaling design for communicating HARQ-ACK feedback via a MAC-CE. As described above, in FIG. 13, different options may be considered for including a first HARQ-ACK part, a second HARQ-ACK part, and/or a HARQ-ACK payload in a MAC-CE, such as based on a network entity 1302 failing to successfully receive and/or decode the first HARQ-ACK part sent via a PUCCH (e.g., by a UE 1304 to the network entity 1302).

Steps 1306-1, 1306-2, 1306-x, 1310, 1312, 1314, and 1316 shown in FIG. 13 may be similar to steps 906-1, 906-2, 906-x, 910, 912, 914, and 916 shown in FIG. 9, respectively. However, different from FIG. 9, the network entity 1302 may fail to successfully receive and/or decode the first HARQ-ACK part sent to network entity 1302 at 1316.

Thus, at 1316, network entity 1302 transmits, to UE 1304, an indication that network entity 1302 failed to decode the first HARQ-ACK part. In certain aspects, this indication is provided in downlink control information (DCI) (e.g., an uplink grant DCI) scheduling a PUSCH. In certain aspects, the indication is provided in a new bit field in the DCI as a bit of “0” (e.g., indicating failure to decode).

Based on receiving the indication, UE 1304 may follow one or more rules to determine whether the first HARQ-ACK part, the second HARQ-ACK part, both the first and second HARQ-ACK parts, or the HARQ-ACK payload (e.g., uncompressed) should be included in a MAC-CE sent to network entity 1302.

In a first option (“Option 1”) following a first rule, the MAC-CE may include the HARQ-ACK payload. That is, based on the network entity 1302 being unable to decode the first HARQ-ACK part, the UE 1304 may fall back to providing the uncompressed HARQ-ACK payload to network entity 1302. Accordingly, at 1318, UE 1304 jointly encodes an uplink payload and the MAC-CE including the uncompressed HARQ-ACK payload. At 1324, UE 1304 transmits, to network entity 1302 via a PUSCH, the MAC-CE (e.g., including the uncompressed HARQ-ACK payload) jointly encoded with the uplink payload.

In a second option (“Option 2”) following a second rule, the MAC-CE may include both the first HARQ-ACK part and the second HARQ-ACK part. Accordingly, at 1318, UE 1304 jointly encodes an uplink payload and the MAC-CE including the first HARQ-ACK part and the second HARQ-ACK part. At 1324, UE 1304 transmits, to network entity 1302 via a PUSCH, the MAC-CE (e.g., including the first and second HARQ-ACK parts) jointly encoded with the uplink payload.

In a third option (“Option 3”) following a third rule, the MAC-CE may include the second HARQ-ACK part without the first HARQ-ACK part. Accordingly, at 1318, UE 1304 jointly encodes an uplink payload and the MAC-CE including only the second HARQ-ACK.

However, providing the second HARQ-ACK part without the first HARQ-ACK part may not be useful for the network entity 1302. Thus, additionally, at 1320, UE 1304 jointly encodes UCI with the first HARQ-ACK part. At 1322, UE 1304 multiplexes the UCI on the PUSCH, used for transmitting the jointly encoded uplink payload and MAC-CE including only the second HARQ-ACK part.

At 1324, UE 1304 transmits, to network entity 1302 via the PUSCH, the MAC-CE (e.g., including only the second HARQ-ACK part) jointly encoded with the uplink payload, multiplexed with the UCI including the first HARQ-ACK part.

Although FIG. 13 describes a scenario where the network entity 1302 fails to successfully receive and/or decode the first HARQ-ACK part sent via the PUCCH, in some other example, the network entity 1302 may successfully receive and decode the first HARQ-ACK part. In such scenarios, the DCI scheduling the PUSCH (e.g., sent by network entity 1302, to UE 1304, at 1316) may include an indication that the network entity 1302 has successfully decoded the first HARQ-ACK part. In certain aspects, this indication is provided in a new bit field in the DCI as a bit of “1” (e.g., indicating successful decoding).

Note that the process flows 900, 1000, 1100, 1200, 1300 illustrated in FIGS. 9, 10, 11, 12, and 13 are described herein to facilitate an understanding of providing HARQ-ACK feedback, such as two part HARQ-ACK feedback, using a MAC-CE, and aspects of the present disclosure may be performed in various manners via alternative or additional signaling and/or operations. In certain aspects, the operations and/or signaling of FIGS. 9, 10, 11, 12, and 13 may occur in an order different from that described or depicted, and various actions, operations, and/or signaling may be added, omitted, or combined.

### Example Operations of a User Equipment

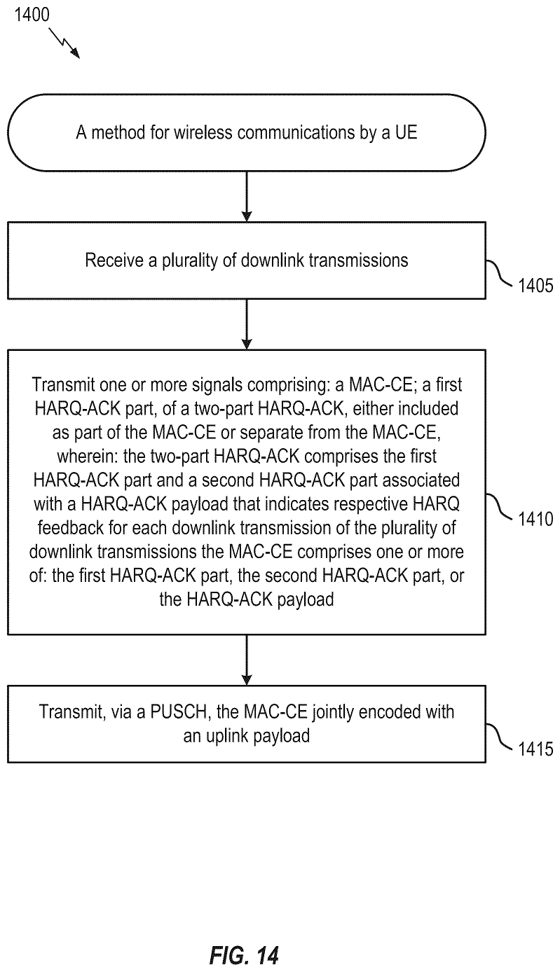

FIG. 14 shows a method 1400 for wireless communications by an apparatus, such as UE 104 of FIG. 1 or UE 304 of FIG. 3.

Method 1400 begins at block 1405 with receiving a plurality of downlink transmissions.

Method 1400 then proceeds to block 1410 with transmitting one or more signals comprising: a MAC-CE; a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload.

Method 1400 then proceeds to block 1415 with transmitting, via a PUSCH, the MAC-CE jointly encoded with an uplink payload.

In some aspects, the MAC-CE comprises the second HARQ-ACK part without the first HARQ-ACK part.

In some aspects, method 1400 further includes separately encoding the first HARQ-ACK part; and block 1410 includes transmitting, via a PUCCH, the first HARQ-ACK part.

In some aspects, the PUCCH and the PUSCH overlap in a time domain.

In some aspects, a time period associated with the PUSCH is later in time than a time period associated with the PUCCH.

In some aspects, transmitting the first HARQ-ACK part comprises transmitting each of a plurality of first HARQ-ACK parts, including the first HARQ-ACK part, via a respective PUCCH; the second HARQ-ACK part is one of a plurality of second HARQ-ACK parts pending transmission; and each second HARQ-ACK part is associated with a respective first HARQ-ACK part of the plurality of first HARQ-ACK parts.

In some aspects, the MAC-CE comprises each second HARQ-ACK part of the plurality of second HARQ-ACK parts.

In some aspects, the MAC-CE further comprises, for each second HARQ-ACK part of the plurality of second HARQ-ACK parts, a respective indication of a respective time period when the associated first HARQ-ACK part was transmitted.

In some aspects, the MAC-CE further comprises an indication of an order associated with the plurality of second HARQ-ACK parts.

In some aspects, the second HARQ-ACK part is associated with the first HARQ-ACK part; and the first HARQ-ACK part is transmitted latest in time among the plurality of first HARQ-ACK parts.

In some aspects, the MAC-CE comprises a subset of the plurality of second HARQ-ACK parts; and the subset comprises at least the second HARQ-ACK part.

In some aspects, method 1400 further includes receiving signaling configuring a number of second HARQ-ACK parts to be included in the subset of the plurality of second HARQ-ACK parts.

In some aspects, the MAC-CE further comprises an indication of an order associated with the subset of the plurality of second HARQ-ACK parts.

In some aspects, the MAC-CE comprises the first HARQ-ACK part and the second HARQ-ACK part.

In some aspects, a first field of the MAC-CE comprises the first HARQ-ACK part; and one or more other fields of the MAC-CE comprise at least the second HARQ-ACK part.

In some aspects, method 1400 further includes receiving signaling configuring the UE to include the first HARQ-ACK part in the first field of the MAC-CE and the second HARQ-ACK part in the one or more other fields of the MAC-CE.

In some aspects, the first field indicates a size of at least one of the one or more other fields of the MAC-CE.

In some aspects, the MAC-CE comprises the first HARQ-ACK part without the second HARQ-ACK part.

In some aspects, the respective HARQ feedback for each downlink transmission of the plurality of downlink transmissions comprises respective ACK feedback for each downlink transmission of the plurality of downlink transmissions.

In some aspects, method 1400 further includes receiving a request to include the first HARQ-ACK part and the second HARQ-ACK part in the MAC-CE.

In some aspects, receiving the request comprises receiving DCI scheduling the PUSCH, the DCI comprising the request.

In some aspects, method 1400 further includes receiving a request to include the second HARQ-ACK part in the MAC-CE without including the first HARQ-ACK part in the MAC-CE.

In some aspects, method 1400 further includes separately encoding the first HARQ-ACK part.

In some aspects, method 1400 further includes receiving DCI scheduling the PUSCH and comprising an indication that a network entity successfully decoded the first HARQ-ACK part; and block 1410 includes transmitting, via a PUCCH, the first HARQ-ACK part.

In some aspects, receiving the request comprises receiving DCI scheduling the PUSCH, the DCI comprising the request.

In some aspects, method 1400 further includes separately encoding the first HARQ-ACK part.

In some aspects, method 1400 further includes receiving DCI scheduling the PUSCH and comprising an indication that a network entity failed to decode the first HARQ-ACK part; and block 1410 includes transmitting, via a PUCCH, the first HARQ-ACK part.

In some aspects, the MAC-CE comprises the HARQ-ACK payload without the first HARQ-ACK part and without the second HARQ-ACK part.

In some aspects, the MAC-CE comprises the first HARQ-ACK part and the second HARQ-ACK part.

In some aspects, the MAC-CE comprises the second HARQ-ACK part without the first HARQ-ACK part.

In some aspects, method 1400 further includes jointly encoding UCI with the first HARQ-ACK part.

In some aspects, method 1400 further includes multiplexing the UCI on the PUSCH.

In some aspects, a size of the second HARQ-ACK part is a function of the first HARQ-ACK part.

In some aspects, a size of the first HARQ-ACK part is fixed.

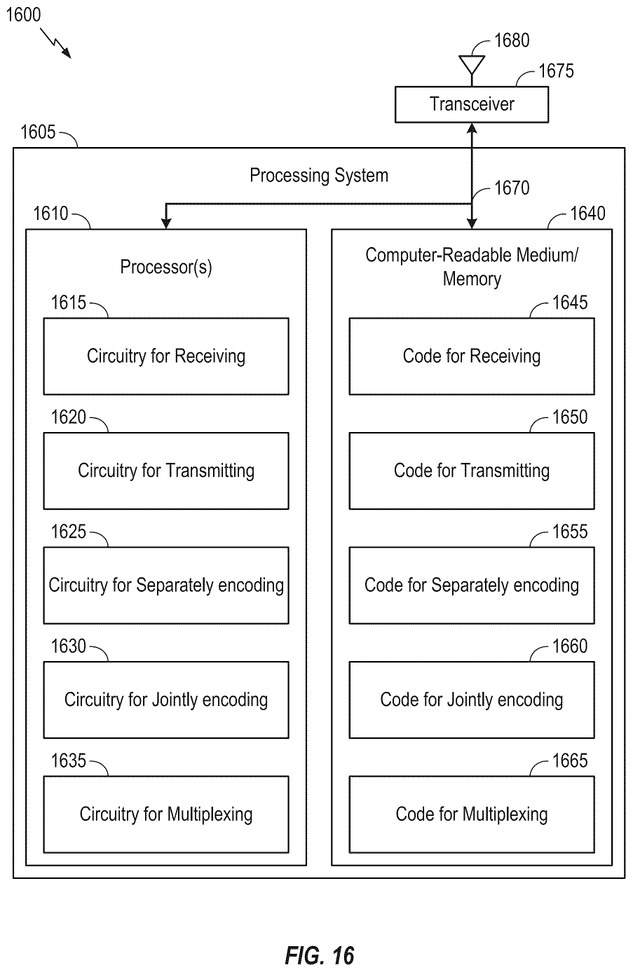

In some aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative operations are possible consistent with this disclosure.

### Example Operations of a Network Entity

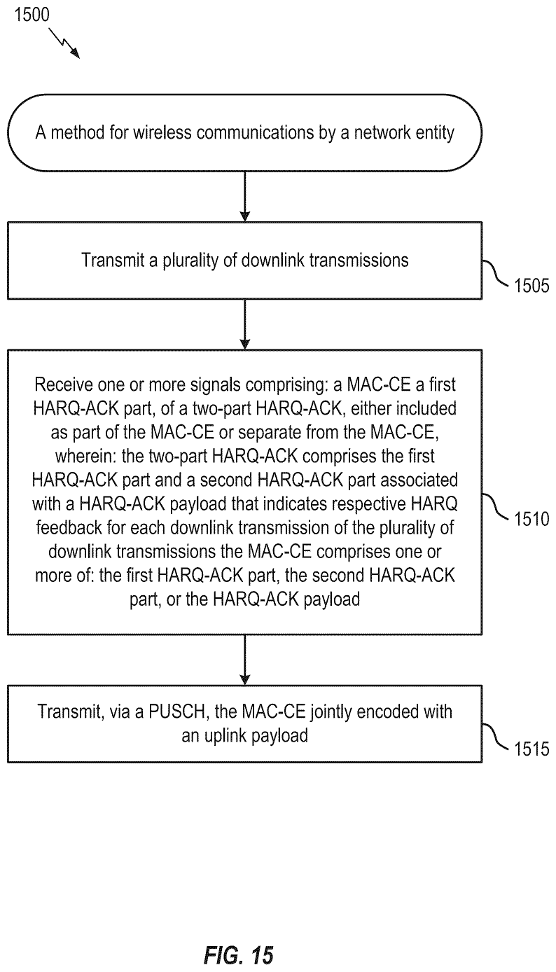

FIG. 15 shows a method 1500 for wireless communications by an apparatus, such as BS 102 of FIG. 1, a first network entity 300 or second network entity 302 of FIG. 3, or a disaggregated base station as discussed with respect to FIG. 2.

Method 1500 begins at block 1505 with transmitting a plurality of downlink transmissions.

Method 1500 then proceeds to block 1510 with receiving one or more signals comprising: a MAC-CE a first HARQ-ACK part, of a two-part HARQ-ACK, either included as part of the MAC-CE or separate from the MAC-CE, wherein: the two-part

HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload.

Method 1500 then proceeds to block 1515 with receiving, via a PUSCH, the MAC-CE jointly encoded with an uplink payload.

In some aspects, the MAC-CE comprises the second HARQ-ACK part without the first HARQ-ACK part.

In some aspects, block 1510 includes receiving, via a PUCCH, the first HARQ-ACK part.

In some aspects, the PUCCH and the PUSCH overlap in a time domain.

In some aspects, a time period associated with the PUSCH is later in time than a time period associated with the PUCCH.

In some aspects, receiving the first HARQ-ACK part comprises receiving each of a plurality of first HARQ-ACK parts, including the first HARQ-ACK part, via a respective PUCCH; the second HARQ-ACK part is one of a plurality of second HARQ-ACK parts pending reception by the network entity; and each second HARQ-ACK part is associated with a respective first HARQ-ACK part of the plurality of first HARQ-ACK parts.

In some aspects, the MAC-CE comprises each second HARQ-ACK part of the plurality of second HARQ-ACK parts.

In some aspects, the MAC-CE further comprises, for each second HARQ-ACK part of the plurality of second HARQ-ACK parts, a respective indication of a respective time period when the associated first HARQ-ACK part was transmitted.

In some aspects, the MAC-CE further comprises an indication of an order associated with the plurality of second HARQ-ACK parts.

In some aspects, the second HARQ-ACK part is associated with the first HARQ-ACK part; and the first HARQ-ACK part is received latest in time among the plurality of first HARQ-ACK parts.

In some aspects, the MAC-CE comprises a subset of the plurality of second HARQ-ACK parts; and the subset comprises at least the second HARQ-ACK part.

In certain aspects, method 1500 further includes transmitting signaling configuring a number of second HARQ-ACK parts to be included in the subset of the plurality of second HARQ-ACK parts.

In some aspects, the MAC-CE further comprises an indication of an order associated with the subset of the plurality of second HARQ-ACK parts.

In some aspects, the MAC-CE comprises the first HARQ-ACK part and the second HARQ-ACK part.

In some aspects, a first field of the MAC-CE comprises the first HARQ-ACK part; and one or more other fields of the MAC-CE comprise at least the second HARQ-ACK part.

In certain aspects, method 1500 further includes transmitting signaling configuring a UE to include the first HARQ-ACK part in the first field of the MAC-CE and the second HARQ-ACK part in the one or more other fields of the MAC-CE.

In some aspects, the first field indicates a size of at least one of the one or more other fields of the MAC-CE.

In some aspects, the MAC-CE comprises the first HARQ-ACK part without the second HARQ-ACK part.

In some aspects, the respective HARQ feedback for each downlink transmission of the plurality of downlink transmissions comprises respective ACK feedback for each downlink transmission of the plurality of downlink transmissions.

In certain aspects, method 1500 further includes transmitting a request to include the first HARQ-ACK part and the second HARQ-ACK part in the MAC-CE.

In some aspects, transmitting the request comprises transmitting DCI scheduling the PUSCH, the DCI comprising the request.

In certain aspects, method 1500 further includes transmitting a request to include the second HARQ-ACK part in the MAC-CE without including the first HARQ-ACK part in the MAC-CE.

In certain aspects, method 1500 further includes transmitting DCI scheduling the PUSCH and comprising an indication that the first HARQ-ACK part was successfully decoded; and block 1510 includes receiving, via a PUCCH, the first HARQ-ACK part.

In some aspects, transmitting the request comprises transmitting DCI scheduling the PUSCH, the DCI comprising the request.

In certain aspects, method 1500 further includes transmitting DCI scheduling the PUSCH and comprising an indication that the first HARQ-ACK part was not successfully decoded; and block 1510 includes receiving, via a PUCCH, the first HARQ-ACK part.

In some aspects, the MAC-CE comprises the HARQ-ACK payload without the first HARQ-ACK part and without the second HARQ-ACK part.

In some aspects, the MAC-CE comprises the first HARQ-ACK part and the second HARQ-ACK part.

In some aspects, the MAC-CE comprises the second HARQ-ACK part without the first HARQ-ACK part.

In certain aspects, method 1500 further includes receiving a re-transmission of the first HARQ-ACK part, wherein the first HARQ-ACK part is jointly encoded with UCI multiplexed on the PUSCH.

In some aspects, a size of the second HARQ-ACK part is a function of the first HARQ-ACK part.

In some aspects, a size of the first HARQ-ACK part is fixed.

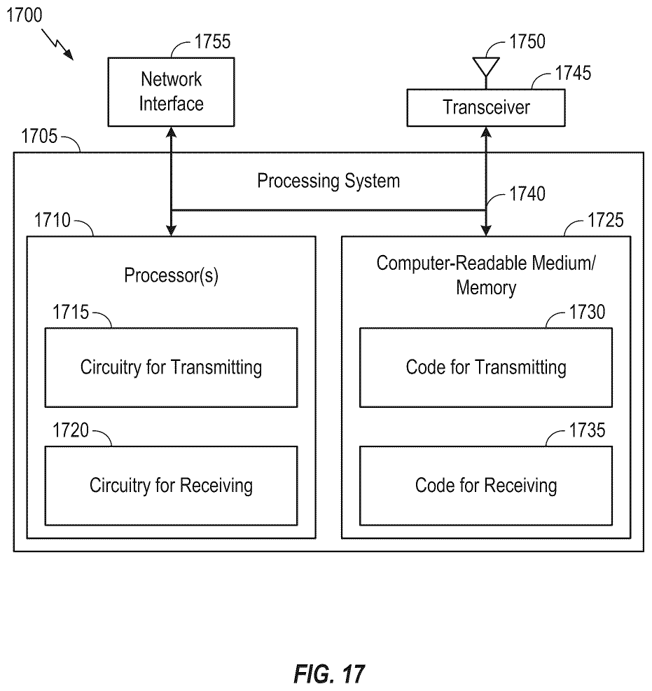

In some aspects, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative operations are possible consistent with this disclosure.

### Example Communications Devices

FIG. 16 depicts aspects of an example communications device 1600 configured for wireless communications. In some aspects, communications device 1600 is a user equipment, such as UE 104 described above with respect to FIG. 1 or UE 304 described with respect to FIG. 3.

The communications device 1600 includes a processing system 1605 coupled to a transceiver 1675 (e.g., a transmitter and/or a receiver). The transceiver 1675 is configured to transmit and receive signals for the communications device 1600 via an antenna 1680, such as the various signals as described herein. The processing system 1605 may be configured to perform processing functions for the communications device 1600, including processing signals received and/or to be transmitted by the communications device 1600.

The processing system 1605 includes one or more processors 1610 and a computer-readable medium/memory 1640. In various aspects, the one or more processors 1610 may be representative of the one or more processors 318 described with respect to FIG. 3. The one or more processors 1610 are coupled to a computer-readable medium/memory 1640 via a bus 1670. In some aspects, the computer-readable medium/memory 1640 may be representative of the one or more memories 320 described with respect to FIG. 3. The computer-readable medium/memory 1640 is a non-transitory computer-readable medium/memory. In certain aspects, the computer-readable medium/memory 1640 is configured to store instructions (e.g., computer-executable code), that when executed by the one or more processors 1610, cause the one or more processors 1610 to perform the method 1400 described with respect to FIG. 14, or any aspect related to it, including any operations described in relation to FIG. 14. Note that reference to a processor performing a function of communications device 1600 may include one or more processors performing that function of communications device 1600, such as in a distributed fashion.

In the depicted example, computer-readable medium/memory 1640 stores code (e.g., executable instructions), including code for receiving 1645, code for transmitting 1650, code for separately encoding 1655, code for jointly encoding 1660, and code for multiplexing 1665. Processing of the code 1645-1665 may enable and cause the communications device 1600 to perform the method 1400 described with respect to FIG. 14, or any aspect related to it.

The one or more processors 1610 include circuitry configured to implement (e.g., execute) the code stored in the computer-readable medium/memory 1640, including circuitry for receiving 1615, circuitry for transmitting 1620, circuitry for separately encoding 1625, circuitry for jointly encoding 1630, and circuitry for multiplexing 1635. Processing with circuitry 1615-1635 may enable and cause the communications device 1600 to perform the method 1400 described with respect to FIG. 14, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1675 and/or antenna 1680 of the communications device 1600 in FIG. 16, and/or one or more processors 1610 of the communications device 1600 in FIG. 16. Means for communicating, receiving or obtaining may include the one or more transceivers 324, one or more antennas 322, and/or processing system 316 of the UE 304 illustrated in FIG. 3, transceiver 1675 and/or antenna 1680 of the communications device 1600 in FIG. 16, and/or one or more processors 1610 of the communications device 1600 in FIG. 16.

FIG. 17 depicts aspects of an example communications device configured for wireless communications. In some aspects, communications device 1700 is a network entity, such as BS 102 of FIG. 1, first network entity 300 or second network entity 302 of FIG. 3, or a disaggregated base station as discussed with respect to FIG. 2.

The communications device 1700 includes a processing system 1705 coupled to a transceiver 1745 (e.g., a transmitter and/or a receiver) and/or a network interface 1755. The transceiver 1745 is configured to transmit and receive signals for the communications device 1700 via an antenna 1750, such as the various signals as described herein. The network interface 1755 is configured to obtain and transmit signals for the communications device 1700 via communications link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710 and a computer-readable medium/memory 1725. In various aspects, one or more processors 1710 may be representative of the one or more processors 308, as described with respect to FIG. 3. The one or more processors 1710 are coupled to the computer-readable medium/memory 1725 via a bus 1740. In certain aspects, the computer-readable medium/memory 1725 is configured to store instructions (e.g., computer-executable code), including code 1730 and 1735, that when executed by the one or more processors 1710, cause the one or more processors 1710 to perform the method 1500 described with respect to FIG. 15, or any aspect related to it, including any operations described in relation to FIG. 15. The computer-readable medium/memory 1725 is a non-transitory computer-readable medium/memory. Note that reference to a processor of communications device 1700 performing a function may include one or more processors of communications device 1700 performing that function, such as in a distributed fashion.

In the depicted example, the computer-readable medium/memory 1725 stores code (e.g., executable instructions), including code for transmitting 1730 and code for receiving 1735. Processing of the code for transmitting 1730 and code for receiving 1735 may enable and cause the communications device 1700 to perform the method 1500 described with respect to FIG. 15, or any aspect related to it.

The one or more processors 1710 include circuitry configured to implement (e.g., execute) the code stored in the computer-readable medium/memory 1725, including circuitry for transmitting 1715 and circuitry for receiving 1720. Processing with circuitry for transmitting 1715 and circuitry for receiving 1720 may enable and cause the communications device 1700 to perform the method 1500 described with respect to FIG. 15, or any aspect related to it.

Various components of the communications device 1700 may provide means for performing the method 1500 described with respect to FIG. 15, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1745, antenna 1750, and/or network interface 1755 of the communications device 1700 in FIG. 17, and/or one or more processors 1710 of the communications device 1700 in FIG. 17. Means for communicating, receiving or obtaining may include the one or more transceivers 312, one or more antennas 314, and/or processing system 306 of the first network entity 300 or the second network entity 302 illustrated in FIG. 3, transceiver 1745, antenna 1750, and/or network interface 1755 of the communications device 1700 in FIG. 17, and/or one or more processors 1710 of the communications device 1700 in FIG. 17.

### Example Clauses

Implementation examples are described in the following numbered clauses:
Clause 1: A method for wireless communications by a UE comprising: receiving a plurality of downlink transmissions; transmitting one or more signals comprising: a MAC-CE; a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload; and transmitting, via a PUSCH, the MAC-CE jointly encoded with an uplink payload.
Clause 2: The method of Clause 1, wherein the MAC-CE comprises the second HARQ-ACK part without the first HARQ-ACK part.
Clause 3: The method of Clause 2, further comprising: separately encoding the first HARQ-ACK part, wherein transmitting the one or more signals comprises transmitting, via a PUCCH, the first HARQ-ACK part.
Clause 4: The method of Clause 3, wherein the PUCCH and the PUSCH overlap in a time domain.
Clause 5: The method of Clause 3, wherein a time period associated with the PUSCH is later in time than a time period associated with the PUCCH.
Clause 6: The method of Clause 3, wherein: transmitting the first HARQ-ACK part comprises transmitting each of a plurality of first HARQ-ACK parts, including the first HARQ-ACK part, via a respective PUCCH; the second HARQ-ACK part is one of a plurality of second HARQ-ACK parts pending transmission; and each second HARQ-ACK part is associated with a respective first HARQ-ACK part of the plurality of first HARQ-ACK parts.
Clause 7: The method of Clause 6, wherein the MAC-CE comprises each second HARQ-ACK part of the plurality of second HARQ-ACK parts.
Clause 8: The method of Clause 7, wherein the MAC-CE further comprises, for each second HARQ-ACK part of the plurality of second HARQ-ACK parts, a respective indication of a respective time period when the associated first HARQ-ACK part was transmitted.
Clause 9: The method of Clause 7, wherein the MAC-CE further comprises an indication of an order associated with the plurality of second HARQ-ACK parts.
Clause 10: The method of Clause 6, wherein: the second HARQ-ACK part is associated with the first HARQ-ACK part; and the first HARQ-ACK part is transmitted latest in time among the plurality of first HARQ-ACK parts.
Clause 11: The method of Clause 6, wherein: the MAC-CE comprises a subset of the plurality of second HARQ-ACK parts; and the subset comprises at least the second HARQ-ACK part.
Clause 12: The method of Clause 11, further comprising: receiving signaling configuring a number of second HARQ-ACK parts to be included in the subset of the plurality of second HARQ-ACK parts.
Clause 13: The method of Clause 11, wherein the MAC-CE further comprises an indication of an order associated with the subset of the plurality of second HARQ-ACK parts.
Clause 14: The method of any one of Clauses 1-13, wherein the MAC-CE comprises the first HARQ-ACK part and the second HARQ-ACK part.
Clause 15: The method of Clause 14, wherein: a first field of the MAC-CE comprises the first HARQ-ACK part; and one or more other fields of the MAC-CE comprise at least the second HARQ-ACK part.
Clause 16: The method of Clause 15, further comprising: receiving signaling configuring the UE to include the first HARQ-ACK part in the first field of the MAC-CE and the second HARQ-ACK part in the one or more other fields of the MAC-CE.
Clause 17: The method of Clause 15, wherein the first field indicates a size of at least one of the one or more other fields of the MAC-CE.
Clause 18: The method of any one of Clauses 1-17, wherein the MAC-CE comprises the first HARQ-ACK part without the second HARQ-ACK part.
Clause 19: The method of Clause 18, wherein the respective HARQ feedback for each downlink transmission of the plurality of downlink transmissions comprises respective ACK feedback for each downlink transmission of the plurality of downlink transmissions.
Clause 20: The method of any one of Clauses 1-19, further comprising: receiving a request to include the first HARQ-ACK part and the second HARQ-ACK part in the MAC-CE.
Clause 21: The method of Clause 20, wherein receiving the request comprises receiving DCI scheduling the PUSCH, the DCI comprising the request.
Clause 22: The method of any one of Clauses 1-21, further comprising: receiving a request to include the second HARQ-ACK part in the MAC-CE without including the first HARQ-ACK part in the MAC-CE.
Clause 23: The method of Clause 22, further comprising: separately encoding the first HARQ-ACK part; and receiving DCI scheduling the PUSCH and comprising an indication that a network entity successfully decoded the first HARQ-ACK part, wherein transmitting the one or more signals comprises transmitting, via a PUCCH, the first HARQ-ACK part.
Clause 24: The method of Clause 22, wherein receiving the request comprises receiving DCI scheduling the PUSCH, the DCI comprising the request.
Clause 25: The method of any one of Clauses 1-24, further comprising: separately encoding the first HARQ-ACK part; and receiving DCI scheduling the PUSCH and comprising an indication that a network entity failed to decode the first HARQ-ACK part, wherein transmitting the one or more signals comprises transmitting, via a PUCCH, the first HARQ-ACK part.
Clause 26: The method of Clause 25, wherein the MAC-CE comprises the HARQ-ACK payload without the first HARQ-ACK part and without the second HARQ-ACK part.
Clause 27: The method of Clause 25, wherein the MAC-CE comprises the first HARQ-ACK part and the second HARQ-ACK part.
Clause 28: The method of Clause 25, wherein the MAC-CE comprises the second HARQ-ACK part without the first HARQ-ACK part.
Clause 29: The method of Clause 28, further comprising: jointly encoding UCI with the first HARQ-ACK part; and multiplexing the UCI on the PUSCH.
Clause 30: The method of any one of Clauses 1-29, wherein a size of the second HARQ-ACK part is a function of the first HARQ-ACK part.
Clause 31: The method of any one of Clauses 1-30, wherein a size of the first HARQ-ACK part is fixed.
Clause 32: A method for wireless communications by a network entity comprising: transmitting a plurality of downlink transmissions; receiving one or more signals comprising: a MAC-CE a first HARQ-ACK part, of a two-part HARQ-ACK, either included as part of the MAC-CE or separate from the MAC-CE, wherein: the two-part HARQ-ACK comprises the first HARQ-ACK part and a second HARQ-ACK part associated with a HARQ-ACK payload that indicates respective HARQ feedback for each downlink transmission of the plurality of downlink transmissions the MAC-CE comprises one or more of: the first HARQ-ACK part, the second HARQ-ACK part, or the HARQ-ACK payload; and receiving, via a PUSCH, the MAC-CE jointly encoded with an uplink payload.
Clause 33: The method of Clause 32, wherein the MAC-CE comprises the second HARQ-ACK part without the first HARQ-ACK part.
Clause 34: The method of Clause 33, wherein receiving the one or more signals comprises receiving, via a PUCCH, the first HARQ-ACK part.
Clause 35: The method of Clause 34, wherein the PUCCH and the PUSCH overlap in a time domain.
Clause 36: The method of Clause 34, wherein a time period associated with the PUSCH is later in time than a time period associated with the PUCCH.
Clause 37: The method of Clause 34, wherein: receiving the first HARQ-ACK part comprises receiving each of a plurality of first HARQ-ACK parts, including the first HARQ-ACK part, via a respective PUCCH; the second HARQ-ACK part is one of a plurality of second HARQ-ACK parts pending reception by the network entity; and each second HARQ-ACK part is associated with a respective first HARQ-ACK part of the plurality of first HARQ-ACK parts.
Clause 38: The method of Clause 37, wherein the MAC-CE comprises each second HARQ-ACK part of the plurality of second HARQ-ACK parts.
Clause 39: The method of Clause 38, wherein the MAC-CE further comprises, for each second HARQ-ACK part of the plurality of second HARQ-ACK parts, a respective indication of a respective time period when the associated first HARQ-ACK part was transmitted.
Clause 40: The method of Clause 38, wherein the MAC-CE further comprises an indication of an order associated with the plurality of second HARQ-ACK parts.
Clause 41: The method of Clause 37, wherein: the second HARQ-ACK part is associated with the first HARQ-ACK part; and the first HARQ-ACK part is received latest in time among the plurality of first HARQ-ACK parts.
Clause 42: The method of Clause 37, wherein: the MAC-CE comprises a subset of the plurality of second HARQ-ACK parts; and the subset comprises at least the second HARQ-ACK part.
Clause 43: The method of Clause 42, further comprising: transmitting signaling configuring a number of second HARQ-ACK parts to be included in the subset of the plurality of second HARQ-ACK parts.
Clause 44: The method of Clause 42, wherein the MAC-CE further comprises an indication of an order associated with the subset of the plurality of second HARQ-ACK parts.
Clause 45: The method of any one of Clauses 32-44, wherein the MAC-CE comprises the first HARQ-ACK part and the second HARQ-ACK part.
Clause 46: The method of Clause 45, wherein: a first field of the MAC-CE comprises the first HARQ-ACK part; and one or more other fields of the MAC-CE comprise at least the second HARQ-ACK part.
Clause 47: The method of Clause 46, further comprising: transmitting signaling configuring a UE to include the first HARQ-ACK part in the first field of the MAC-CE and the second HARQ-ACK part in the one or more other fields of the MAC-CE.
Clause 48: The method of Clause 46, wherein the first field indicates a size of at least one of the one or more other fields of the MAC-CE.
Clause 49: The method of any one of Clauses 32-48, wherein the MAC-CE comprises the first HARQ-ACK part without the second HARQ-ACK part.
Clause 50: The method of Clause 49, wherein the respective HARQ feedback for each downlink transmission of the plurality of downlink transmissions comprises respective ACK feedback for each downlink transmission of the plurality of downlink transmissions.
Clause 51: The method of any one of Clauses 32-50, further comprising: transmitting a request to include the first HARQ-ACK part and the second HARQ-ACK part in the MAC-CE.
Clause 52: The method of Clause 51, wherein transmitting the request comprises transmitting DCI scheduling the PUSCH, the DCI comprising the request.
Clause 53: The method of any one of Clauses 32-52, further comprising: transmitting a request to include the second HARQ-ACK part in the MAC-CE without including the first HARQ-ACK part in the MAC-CE.
Clause 54: The method of Clause 53, further comprising: transmitting DCI scheduling the PUSCH and comprising an indication that the first HARQ-ACK part was successfully decoded, wherein receiving the one or more signals comprises receiving, via a PUCCH, the first HARQ-ACK part.
Clause 55: The method of Clause 53, wherein transmitting the request comprises transmitting DCI scheduling the PUSCH, the DCI comprising the request.
Clause 56: The method of any one of Clauses 32-55, further comprising: transmitting DCI scheduling the PUSCH and comprising an indication that the first HARQ-ACK part was not successfully decoded, wherein receiving the one or more signals comprises receiving, via a PUCCH, the first HARQ-ACK part.
Clause 57: The method of Clause 56, wherein the MAC-CE comprises the HARQ-ACK payload without the first HARQ-ACK part and without the second HARQ-ACK part.
Clause 58: The method of Clause 56, wherein the MAC-CE comprises the first HARQ-ACK part and the second HARQ-ACK part.
Clause 59: The method of Clause 56, wherein the MAC-CE comprises the second HARQ-ACK part without the first HARQ-ACK part.
Clause 60: The method of Clause 59, further comprising: receiving a re-transmission of the first HARQ-ACK part, wherein the first HARQ-ACK part is jointly encoded with UCI multiplexed on the PUSCH.
Clause 61: The method of any one of Clauses 32-60, wherein a size of the second HARQ-ACK part is a function of the first HARQ-ACK part.
Clause 62: The method of any one of Clauses 32-61, wherein a size of the first HARQ-ACK part is fixed.
Clause 63: One or more apparatuses, comprising: one or more memories comprising executable instructions; and one or more processors configured to execute the executable instructions and cause the one or more apparatuses to perform a method in accordance with any one of Clauses 1-62.
Clause 64: One or more apparatuses configured for wireless communications, comprising: one or more memories; and one or more processors, coupled to the one or more memories, configured to cause the one or more apparatuses to perform a method in accordance with any one of Clauses 1-62.
Clause 65: One or more apparatuses configured for wireless communications, comprising: one or more memories; and one or more processors, coupled to the one or more memories, configured to perform a method in accordance with any one of Clauses 1-62.
Clause 66: One or more apparatuses, comprising means for performing a method in accordance with any one of Clauses 1-62.
Clause 67: One or more non-transitory computer-readable media comprising executable instructions that, when executed by one or more processors of one or more apparatuses, cause the one or more apparatuses to perform a method in accordance with any one of Clauses 1-62.
Clause 68: One or more computer program products embodied on one or more computer-readable storage media comprising code for performing a method in accordance with any one of Clauses 1-62.
Clause 69: One or more apparatuses configured for wireless communications, comprising: a processing system that includes one or more processors and one or more memories coupled with the one or more processors, the processing system configured to cause the one or more apparatuses to perform a method in accordance with any one of Clauses 1-62.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive a plurality of downlink transmissions;
transmit one or more signals comprising:
a medium access control (MAC) control element (MAC-CE); and
a first hybrid automatic repeat request acknowledgement (HARQ-ACK) part, of a two-part HARQ-ACK, either included as part of the MAC-CE or separate from the MAC-CE, wherein:
the two-part HARQ-ACK comprises the first HARQ-ACK part and a second HARQ-ACK part associated with a HARQ-ACK payload that indicates respective HARQ feedback for each downlink transmission of the plurality of downlink transmissions; and
the MAC-CE comprises one or more of: the first HARQ-ACK part, the second HARQ-ACK part, or the HARQ-ACK payload; and
transmit, via a physical uplink shared channel (PUSCH), the MAC-CE jointly encoded with an uplink payload.

2. The apparatus of claim 1, wherein the MAC-CE comprises the second HARQ-ACK part without the first HARQ-ACK part.

3. The apparatus of claim 2, wherein:
the processing system is configured to cause the UE to separately encode the first HARQ-ACK part; and
to cause the UE to transmit the one or more signals, the processing system is configured to cause the UE to transmit, via a physical uplink control channel (PUCCH), the first HARQ-ACK part.

4. The apparatus of claim 3, wherein:
to cause the UE to transmit the first HARQ-ACK part, the processing system is configured to cause the UE to transmit each of a plurality of first HARQ-ACK parts, including the first HARQ-ACK part, via a respective PUCCH;
the second HARQ-ACK part is one of a plurality of second HARQ-ACK parts pending transmission; and
each second HARQ-ACK part is associated with a respective first HARQ-ACK part of the plurality of first HARQ-ACK parts.

5. The apparatus of claim 4, wherein the MAC-CE comprises each second HARQ-ACK part of the plurality of second HARQ-ACK parts.

6. The apparatus of claim 4, wherein:
the second HARQ-ACK part is associated with the first HARQ-ACK part; and
the first HARQ-ACK part is transmitted latest in time among the plurality of first HARQ-ACK parts.

7. The apparatus of claim 4, wherein:
the MAC-CE comprises a subset of the plurality of second HARQ-ACK parts; and
the subset comprises at least the second HARQ-ACK part.

8. The apparatus of claim 1, wherein the MAC-CE comprises the first HARQ-ACK part and the second HARQ-ACK part.

9. The apparatus of claim 8, wherein:
a first field of the MAC-CE comprises the first HARQ-ACK part; and
one or more other fields of the MAC-CE comprise at least the second HARQ-ACK part.

10. The apparatus of claim 1, wherein:
the respective HARQ feedback for each downlink transmission of the plurality of downlink transmissions comprises respective acknowledgement (ACK) feedback for each downlink transmission of the plurality of downlink transmissions; and
the MAC-CE comprises the first HARQ-ACK part without the second HARQ-ACK part.

11. The apparatus of claim 1, wherein the processing system is configured to cause the UE to receive downlink control information (DCI) scheduling the PUSCH, the DCI comprising a request to include the first HARQ-ACK part and the second HARQ-ACK part in the MAC-CE.

12. The apparatus of claim 1, wherein the processing system is configured to cause the UE to receive a request to include the second HARQ-ACK part in the MAC-CE without including the first HARQ-ACK part in the MAC-CE.

13. The apparatus of claim 12, wherein:
the processing system is configured to cause the UE to:
separately encode the first HARQ-ACK part; and
receive downlink control information (DCI) scheduling the PUSCH and comprising an indication that a network entity successfully decoded the first HARQ-ACK part; and
to cause the UE to transmit the one or more signals, the processing system is configured to cause the UE to transmit, via a physical uplink control channel (PUCCH), the first HARQ-ACK part.

14. The apparatus of claim 1, wherein:
the processing system is configured to cause the UE to:
separately encode the first HARQ-ACK part; and
receive downlink control information (DCI) scheduling the PUSCH and comprising an indication that a network entity failed to decode the first HARQ-ACK part; and
to cause the UE to transmit the one or more signals, the processing system is configured to cause the UE to transmit, via a physical uplink control channel (PUCCH), the first HARQ-ACK part.

15. The apparatus of claim 14, wherein the MAC-CE comprises the HARQ-ACK payload without the first HARQ-ACK part and without the second HARQ-ACK part.

16. The apparatus of claim 14, wherein the MAC-CE comprises the first HARQ-ACK part and the second HARQ-ACK part.

17. The apparatus of claim 14, wherein the MAC-CE comprises the second HARQ-ACK part without the first HARQ-ACK part.

18. The apparatus of claim 17, wherein the processing system is configured to cause the UE to:
jointly encode uplink control information (UCI) with the first HARQ-ACK part; and
multiplex the UCI on the PUSCH.

19. A method of wireless communications by an apparatus, comprising:
receiving a plurality of downlink transmissions;
transmitting one or more signals comprising:
a medium access control (MAC) control element (MAC-CE); and
a first hybrid automatic repeat request acknowledgement (HARQ-ACK) part, of a two-part HARQ-ACK, either included as part of the MAC-CE or separate from the MAC-CE, wherein:
the two-part HARQ-ACK comprises the first HARQ-ACK part and a second HARQ-ACK part associated with a HARQ-ACK payload that indicates respective HARQ feedback for each downlink transmission of the plurality of downlink transmissions; and
the MAC-CE comprises one or more of: the first HARQ-ACK part, the second HARQ-ACK part, or the HARQ-ACK payload; and
transmitting, via a physical uplink shared channel (PUSCH), the MAC-CE jointly encoded with an uplink payload.

20. One or more non-transitory computer-readable media comprising executable instructions that, when executed by one or more processors of an apparatus, cause the apparatus to perform operations comprising:
receiving a plurality of downlink transmissions;
transmitting one or more signals comprising:
a medium access control (MAC) control element (MAC-CE); and
a first hybrid automatic repeat request acknowledgement (HARQ-ACK) part, of a two-part HARQ-ACK, either included as part of the MAC-CE or separate from the MAC-CE, wherein:
the two-part HARQ-ACK comprises the first HARQ-ACK part and a second HARQ-ACK part associated with a HARQ-ACK payload that indicates respective HARQ feedback for each downlink transmission of the plurality of downlink transmissions; and
the MAC-CE comprises one or more of: the first HARQ-ACK part, the second HARQ-ACK part, or the HARQ-ACK payload; and
transmitting, via a physical uplink shared channel (PUSCH), the MAC-CE jointly encoded with an uplink payload.
